(19) United States
(12) Patent Application Publication
(10) Pub. No.: US 2015/0089429 A1
(43) Pub. Date: Mar. 26, 2015

(54) Very Thin Virtual Keyboards and Keyboard Locators

(71) Applicant: Yoram Ghassabian, Great Neck, NY (US)

(72) Inventor: Yoram Ghassabian, Great Neck, NY (US)

(21) Appl. No.: 14/037,791

(22) Filed: Sep. 26, 2013

(51) Int. Cl. G06F 3/0488

(52) U.S. Cl. CPC G06F 3/04886
USPC 715/773

(57) ABSTRACT

There is proposed a digital processing device including a display incorporating a virtual keyboard locator, having an elongated shape extending along one side of the display. The locator includes—partly invisible keys, and—visible alphabetical characters arranged into three rows (upper, middle, and lower). The middle row's characters indicate locations of corresponding visible alphabetical keys, situated on the visible parts. The upper row's characters indicate locations of the partly invisible keys, located on the display partly outside and above the visible parts. The lower row's characters indicate locations of the partly invisible keys, situated on the display partly outside and below the visible parts. In embodiments, the middle row's characters are increased to be inserted between the upper and lower rows' characters providing compactness of the locator and an intuitive visual separation effect between the three rows. The three rows can be arranged in a conventional three-row Qwerty keyboard order.

### CROSS REFERENCE TO RELATED APPLICATIONS

The present U.S. utility patent application claims the benefit under 35 USC 119 (e) of a U.S. provisional patent application No. 61/795,335 filed on Oct. 15, 2012, whose disclosure is hereby incorporated by reference in its entirety. The present U.S. utility patent application also claims the benefit under 35 USC 119 (e) of a U.S. provisional patent application No. 61/848,190 filed on Dec. 27, 2012, whose disclosure is hereby incorporated by reference in its entirety. Some of the basic ideas contained in the present application were first described in US2010/0245252 filed on Jan. 13, 2010 by the instant inventor, and also incorporated by reference in its entirety.

### FIELD OF THE INVENTION

The instant invention relates to alphabetical keyboard units, particularly to virtual alphabetical keyboard units for processing devices such as mobile telecommunication devices.

### BACKGROUND OF THE INVENTION

Nowadays, most alphabetical keyboards for mobile telecommunication devices are virtual ones appearing on the displays of said devices. These virtual alphabetical keyboards comprise conventionally four rows of fully visible keys. As a consequence, these conventional virtual keyboards are spreading on a substantial portion of the area of the displays of said devices. A conventional virtual keyboard usually can expand over half of the area of a display. Thus, any other software application becomes, for a substantial part of it, not visible anymore on the display when said large, conventional, and fully visible virtual alphabetical keyboard is being used.

As a consequence, in order to free the real estate of the display when a virtual alphabetical keyboard is being used, there is known U.S. patent application Ser. No. 12/657,147 describing a virtual alphabetical keyboard unit whose alphabetical keys, and/or characters, extend in a thin linear manner along at least a substantial portion of the perimeter of said display. This peripheral virtual keyboard, while being used, still allows the images of any other software applications to be fully (if not at least substantially) visible, and this because of its particular shape which leaves the center part of the display open and free in order to see any said other software application images.

Moreover, said virtual alphabetical keyboard unit can comprise alphabetical keys which can be at least partly invisible for said unit to be even thinner and less invasive when extending in a linear shape along at least one side of the display. The locations of said at least partly invisible alphabetical keys on the display are indicated by the visible alphabetical characters appearing on said unit. In fact, and according to said U.S. patent application Ser. No. 12/657,147, said unit is named and generally defined as: a virtual alphabetical keyboard locator unit, having a thin linear shape, extending along at least one side of the display of a mobile telecommunication device, said unit displaying a set of visible alphabetical characters which, at least through their particular arrangement, indicate: 1) the locations of corresponding alphabetical keys, and/or rows of keys, located at least on the visible parts of said unit, and/or 2) the locations of at least partly invisible alphabetical keys, and/or rows of keys, corresponding to said alphabetical characters, and which are located, on the display, at least partly outside the visible parts of said unit. According to said U.S. patent application Ser. No. 12/657,147, said unit comprises at least one row of visible alphabetical characters.

But the aforementioned virtual alphabetical keyboard locator unit extending along at least one side of the display in a thin linear shape may have a disadvantage. Its visible alphabetical characters are mostly described in a basic alphabetical order arrangement (i.e. from character A to character Z) along at least a substantial portion of the perimeter of the display. But most virtual alphabetical keyboards for mobile telecommunication devices have a Qwerty arrangement of their alphabetical characters, and most users are used to said conventional Qwerty arrangement. It is an arrangement which they have learned and used since their first years at school, and this habit can be difficult to change.

### OBJECTS AND SUMMARY OF THE INVENTION

Many of the basic inventive ideas and principles described in this patent application are at least closely related to the invention of an alphabetical keyboard locator, having a thin linear shape, herein also called an ‘elongated’ shape (i.e. the length of said locator is significantly greater than its width), extending along at least one side of the display of a mobile telecommunication device, said locator displaying a set of visible alphabetical characters, which, at least through their particular arrangement, indicate:

a) The locations of corresponding alphabetical keys, and/or rows of keys, located at least on the visible parts of said locator, and/or

b) The locations of at least partly invisible alphabetical keys, and/or rows of keys, corresponding to said alphabetical characters, and which are located, on the display, at least partly outside the visible parts of said locator.

Thus, the primary aim of the present invention is to provide a virtual alphabetical keyboard locator unit for a telecommunication, computing, or similar device, herein also collectively called a ‘processing device’, having a screen (display). Said unit extends along at least one side of said display in a thin linear shape which is non-invasive. The alphabetical characters of said unit are arranged in a conventional, well known, Qwerty order. Said aforementioned characteristics of the unit would enable a user to quickly and conveniently enter alphabetical characters in a particular place of the screen, while at the same time allowing said user to see the images of other applications appearing on said screen. Other aims of the invention might become apparent to one skilled in the art upon learning the present disclosure.

Accordingly, a digital processing device is herein proposed. The device comprises a display, said display includes an alphabetical keyboard locator; said locator has an elongated shape extending along at least one side of said display; said locator comprises:

at least partly invisible parts including at least partly invisible keys and/or a row of keys;

visible parts including a set of visible alphabetical characters arranged into three rows: an upper row, a middle row, and a lower row, and wherein:

a) the alphabetical characters of the middle row indicate locations of the corresponding visible alphabetical keys and/or row of keys, situated at least on said visible parts;

b) the alphabetical characters of the upper row indicate locations of said at least partly invisible keys and/or row of keys, located on the display at least partly outside and above said visible parts; and

c) the alphabetical characters of the lower row indicate locations of at least partly invisible keys, and/or row of keys, situated on the display at least partly outside and below said visible parts.

The ‘elongated shape’ herein means that the length of the virtual keyboard locator is significantly greater than a visible width thereof. Also, the rows of alphabetical characters are compressed/compacted against one another in order to form a virtual keyboard locator having the elongated shape.

Moreover, said three rows are arranged in a conventional order of three-row Qwerty keyboard alphabetical characters, and wherein:

a) a conventional middle row of Qwerty keyboard alphabetical characters is represented by the alphabetical characters of the middle row of said locator;
b) a conventional upper row of Qwerty keyboard alphabetical characters is represented by the alphabetical characters of the upper row of said locator; and
c) a conventional lower row of Qwerty keyboard alphabetical characters is represented by the alphabetical characters of the lower row of said locator.

In general, the invention contemplates a processing device, and/or an electronic device, such as a mobile telecommunication device, which comprises a display, on which appears an image of an alphabetical keyboard locator, (herein called a ‘virtual keyboard locator’), said locator comprising: at least one side of the display, at least three rows of visible alphabetical keys and/or characters extending in an elongated shape (i.e. the height of the alphabetical keys and/or characters of said row is significantly less than the length of said row). Particular preferred embodiments of the invention are disclosed herein below.

### BRIEF DESCRIPTION OF DRAWINGS OF THE INVENTION

FIG. 1 shows three conventional alphabetical rows of a Qwerty keyboard contiguous to each other and each in the shape of a very thin line. These three rows of alphabetical characters and/or keys form together a software window in shape of a thin rectangular band. The middle row is visible in its entirety. The surfaces of the upper and lower rows are only partly visible to the user on the display. Said upper and lower rows are only the visible portions, in the shape of thin lines, of larger invisible rows of keys on the display.

FIG. 2 shows a virtual keyboard locator unit in the shape of a thin band comprising the three conventional rows of alphabetical characters of a Qwerty keyboard which are not separated between them by visual border lines. The images of the alphabetical characters of the top and/or lower rows appear, at least substantially, at same level than the images of the alphabetical characters of middle row. The alphabetical characters of the middle row can be visually distinguished from the alphabetical characters of the upper and/or lower external rows. The middle row is visible in its entirety. The surfaces of the upper and lower rows are only partly visible to the user on the display. Said upper and lower rows are only the visible portions, in the shape of thin lines, of larger invisible rows of keys on the display.

FIG. 3 shows three conventional alphabetical rows of a Qwerty keyboard slightly separated from each other and each in the shape of a very thin line. These three rows of alphabetical characters and/or keys form together a software window in shape of a thin rectangular band. The middle row can be visible in its entirety and/or at least partly invisible. The surfaces of the upper and lower rows are only partly visible to the user on the display. Said upper and lower rows are only the visible portions, in the shape of thin lines, of larger invisible rows of keys on the display.

FIG. 4 shows a virtual alphabetical keyboard unit which at least comprises the three conventional alphabetical rows of keys and/or characters of a conventional Qwerty keyboard. Each of said rows extends in the shape of a very thin elongated line which results in the creation of large and transparent zones between said alphabetical rows allowing the user to see the background images of other applications on the display. Said rows of alphabetical keys and/or characters can act as visible locators of partly invisible and/or fully invisible alphabetical keys and/or row of alphabetical keys on the display.

FIG. 5 shows the virtual keyboard unit of FIG. 4 which thin/elongated rows are not surrounded by any visible border and/or limit lines.

FIG. 6 shows an advertisement image appearing in a conventional rectangular software window of an ad banner being replaced by the image of a virtual keyboard locator unit, after a user selects another software window for entering a keyword.

FIG. 7 shows an advertisement image replacing the image of the virtual alphabetical keyboard locator of FIG. 6 in said conventional rectangular software window of an ad banner, after said user enters a keyword. Said advertisement image is preferably relating to said keyword entered.

FIG. 8 shows a virtual alphabetical Qwerty keyboard unit comprising one row having the unambiguous alphabetical keys and/or characters of a upper Qwerty row, and at least one ambiguous key to which are assigned the alphabetical characters of at least one of the two alphabetical bottom rows of a Qwerty keyboard unit.

FIG. 9 shows a virtual Qwerty keyboard comprising at least one very thin row of alphabetical keys which are at least partly invisible, and which can be located by corresponding visible alphabetical characters appearing on said very thin row. Said partly invisible and/or fully invisible alphabetical keys are located either: 1) above their respective visible key locator, and/or 2) on their respective visible key locator, and/or 3) below their respective visible key locator.

FIG. 10 shows a virtual Qwerty keyboard unit comprising at least one partly invisible row of alphabetical keys whose visible area has an overall thin and/or elongated horizontal shape, and whose invisible area becomes visible if a user selects a visible and/or an invisible area of at least one key of said row.

FIG. 11 shows a virtual Qwerty keyboard unit expanding on a wide area on the display of a mobile telecommunication device, wherein said area is occupied: 1) in minority, by smaller zones having thin horizontal shapes, and on which alphabetical keys appear, and 2) in majority, by substantially larger keyless zones, expanding also horizontally, and located between said small zones.

FIG. 12 shows the same virtual Qwerty keyboard unit of FIG. 11 with the difference that said smaller zones and substantially larger zones are not surrounded by any visible border lines.

FIG. 13 shows a virtual Qwerty keyboard locator unit having the shape of a thin band which extremities can have a curved shape design. Also, FIG. 13 shows additional key locator instruments, appearing next to some key locators, and which indicate to the user the invisible locations on the display of keys that can be located further away from, and/or closer to, their respective key locators.

FIG. 14 shows a mobile telecommunication device comprising an apparatus for detecting the location of a user's finger over its display without said finger touching it, and wherein a virtual Qwerty keyboard locator unit expending on a wide area is located on said display, and wherein at least some of the keys of said unit are either at least partly invisible and/or fully invisible, and wherein at least one said key becomes visible, and/or appear in substantially larger dimensions, when said finger is located over an area assigned to at least one key.

FIG. 15 shows a mobile telecommunication device comprising an apparatus for detecting the location of a user's finger over its display of without said finger touching it, and wherein a virtual Qwerty keyboard locator unit having a thin linear shape is located on said display, and wherein at least some of the keys of said unit are either at least partly invisible and/or fully invisible, and wherein at least one said key becomes visible, and/or appear in substantially larger dimensions, when said finger is located over an area assigned to at least one key.

FIG. 16 shows a virtual alphanumerical keyboard locator unit having the shape of a thin band and comprising the three conventional levels of alphabetical characters of a Qwerty keyboard. The alphabetical characters of said three levels are contiguous to each other, and are extending side by side, without border lines separating them.

FIG. 16A shows a variation from the keyboard locator unit of FIG. 16. The dimensions of the alphabetical characters of the middle row are increased to the point that the images of said middle row characters insert themselves between the images of the characters of the upper row and/or lower row.

FIG. 16B shows a variation from the keyboard locator unit of FIG. 16. The dimensions of the alphabetical characters of the middle row are increased to the point that the images of said middle row characters expand even higher than the level of the characters of the upper row, and/or even lower than the characters of the lower row. The characters of the top and lower rows are included into the level of the middle row.

FIG. 17 shows a strictly one row/level of virtual alphabetical characters organized in a Qwerty alphabetical order.

FIG. 17A shows a virtual keyboard locator unit originating from the strictly one row/level virtual alphabetical characters of FIG. 17, wherein the upper row alphabetical characters are minimized upward, the lower row alphabetical characters are minimized downward, and the alphabetical characters of the middle row keep their same original dimensions.

FIG. 17B shows a strictly one row/level of virtual alphabetical characters organized in a basic alphabetical order from the character “A” to the character “Z” and from the left side to the right side.

FIG. 17C shows a virtual keyboard locator unit originating from the strictly one row/level virtual alphabetical characters of FIG. 17B, wherein some the alphabetical characters are minimized upward, some alphabetical characters of are minimized downward, and some alphabetical characters keep their same original dimensions.

FIG. 18 shows the virtual keyboard locator unit having a thin linear shape comprising basic command characters and/or keys that are located at least on its middle and/or lower rows/levels.

FIG. 19 shows the thin linear virtual keyboard locator unit in a numerical, and/or symbol, and/or special character mode.

FIG. 20 shows a virtual alphanumerical keyboard locator unit having the shape of a thin band and comprising three levels of alphabetical characters arranged in a basic alphabetical order starting from the upper row, continuing through the middle row and finishing on the lower row. The alphabetical characters of said three levels are contiguous to each other, and are extending side by side, without border lines separating them.

FIG. 20A shows a variation from the keyboard locator unit of FIG. 16. The dimensions of the alphabetical characters of the middle row are increased to the point that the images of said middle row characters insert themselves between the images of the characters of the upper row and/or lower row.

FIG. 20B shows a variation from the keyboard locator unit of FIG. 16. The dimensions of the alphabetical characters of the middle row are increased to the point that the images of said middle row characters expand even higher than the level of the characters of the upper row, and/or even lower than the characters of the lower row. The characters of the top and lower rows are included into the level of the middle row.

FIG. 21 shows a strictly one row/level of virtual alphabetical characters organized in a basic alphabetical order from the character “A” to the character “Z” and from the left side to the right side.

FIG. 21A shows a virtual keyboard locator unit originating from the strictly one row/level virtual alphabetical characters of FIG. 21, wherein said alphabetical characters are arranged in a “wavy” manner/design, and wherein for every two characters one character stays on the middle row while the other character is placed either upward or downward.

FIG. 21B shows a virtual keyboard locator unit originating from the strictly one row/level virtual alphabetical characters of FIG. 21, wherein said alphabetical characters are arranged in a in a visually synchronized manner having a “\” or “slash” shape, and wherein for every three characters, one is placed upward, one stays on the middle row, and one is placed downward.

FIG. 21C shows a virtual keyboard locator unit originating from the strictly one row/level virtual alphabetical characters of FIG. 21, wherein the alphabetical characters that are on average the most used in a text entry are placed on the middle row, and the characters that are on average the less used in a text entry are placed upward and/or downward.

### DETAIL DESCRIPTION OF PREFERRED EMBODIMENTS OF THE INVENTION

While the inventions described in this patent application may be susceptible to embodiment in different forms, there are shown in the drawings, and will be described in detail herein, specific embodiments of the instant inventions, with the understanding that the present disclosure is to be considered an exemplification of the principles of the inventions, and is not intended to limit the inventions to that as illustrated and described herein.

Therefore, according to the invention, a digital processing device comprises a display, said display includes an alphabetical keyboard locator; said locator has an elongated shape extending along at least one side of said display; said locator comprises:

at least partly invisible parts including at least partly invisible keys and/or a row of keys;

visible parts including a set of visible alphabetical characters arranged into three rows: an upper row, a middle row, and a lower row, and wherein:

a) the alphabetical characters of the middle row indicate locations of the corresponding visible alphabetical keys and/or row of keys, situated at least on said visible parts;
b) the alphabetical characters of the upper row indicate locations of said at least partly invisible keys and/or row of keys, located on the display at least partly outside and above said visible parts; and
c) the alphabetical characters of the lower row indicate locations of at least partly invisible keys, and/or row of keys, situated on the display at least partly outside and below said visible parts.

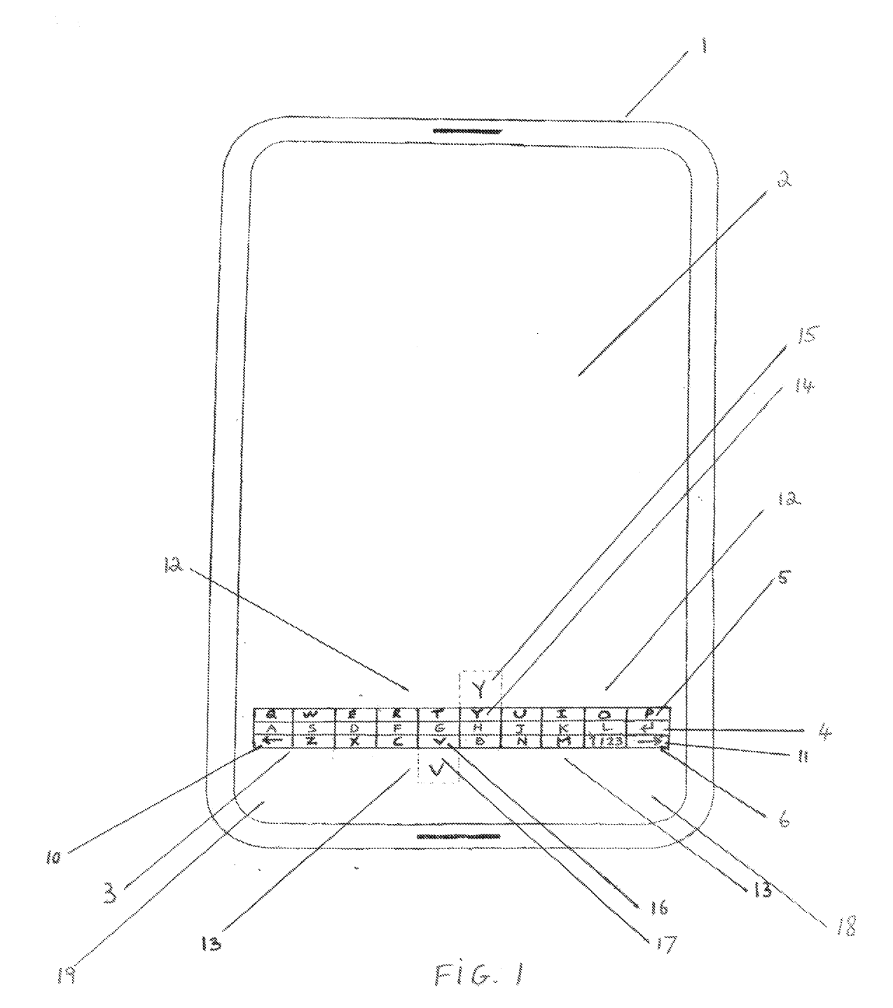

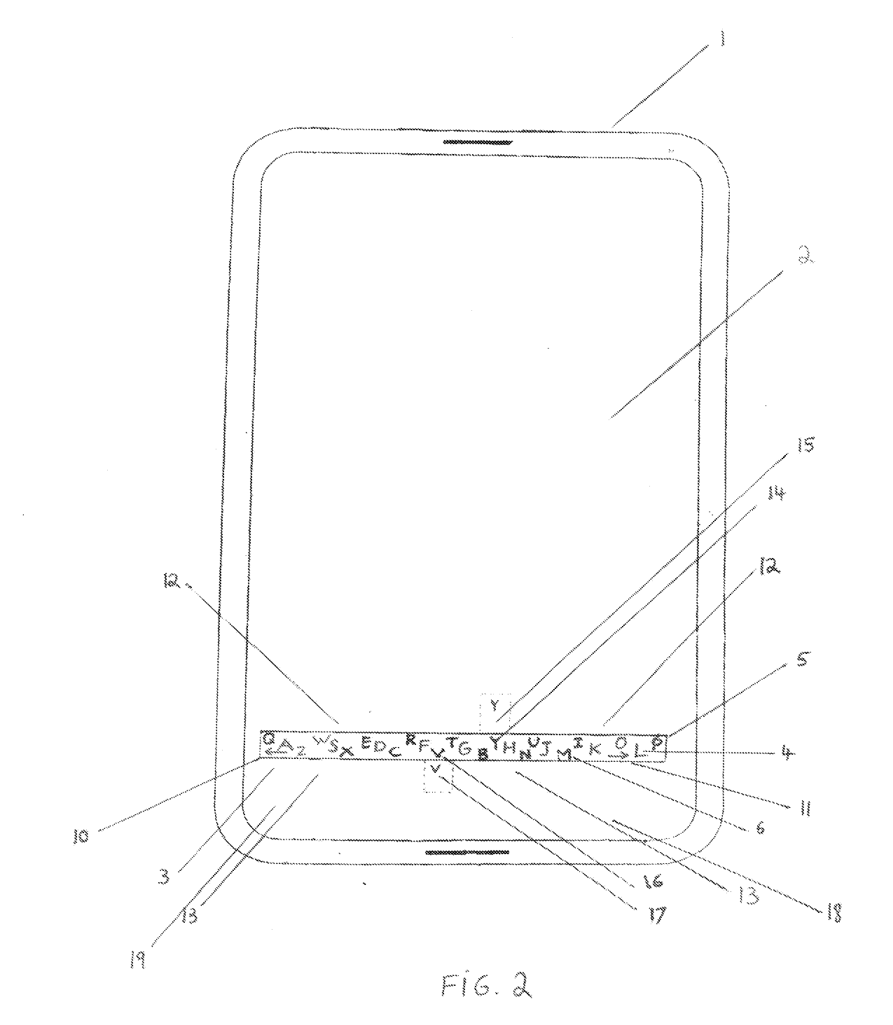

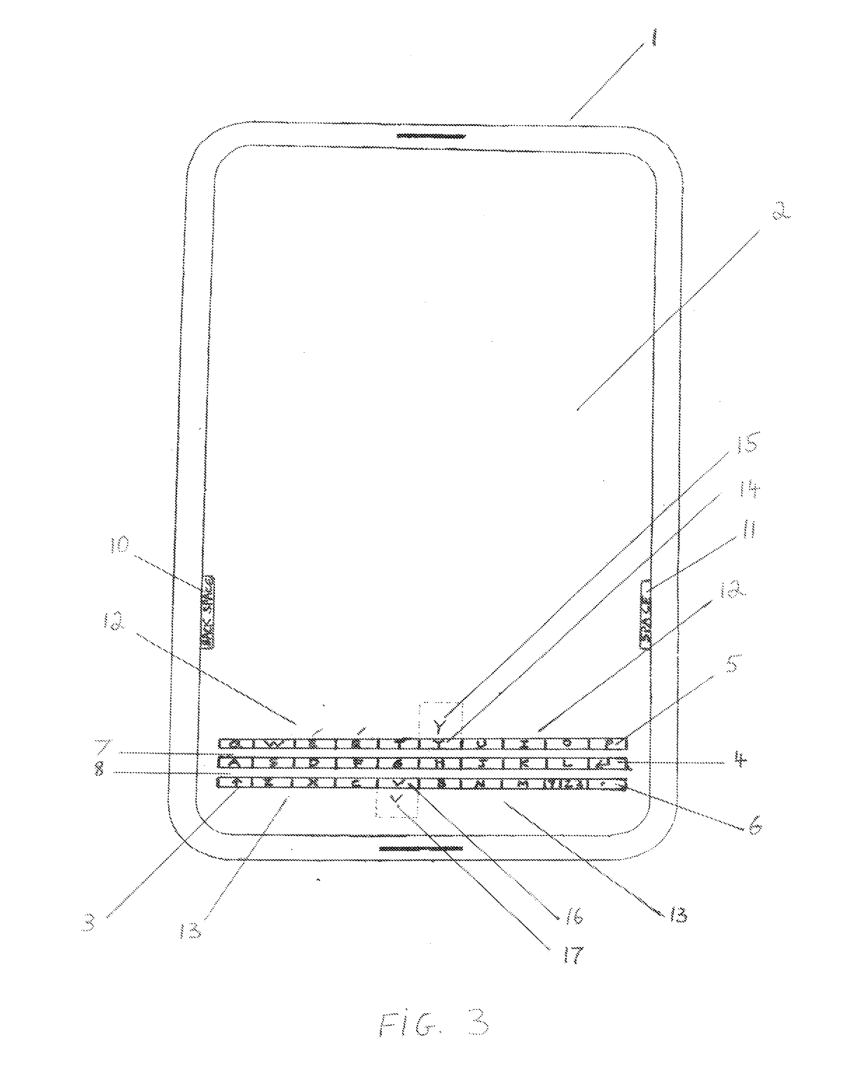

FIG. 1, and/or FIG. 2, and/or FIG. 3 depict embodiments of some of the basic ideas and principles of the invention. They show a mobile electronic telecommunication device (1) (such as, but not limited to, a smart phone, or a tablet computer, or a smart watch, etc.) including a display (2), a virtual keyboard locator unit (3) located on and/or extending along at least a portion of at least one side of the display (2). This virtual keyboard locator unit (3) comprises preferably at least three rows, and/or levels, of alphabetical keys and/or characters.

According to the invention, the virtual keyboard locator unit indicates to the user the locations of partly invisible and/or fully invisible alphabetical keys anywhere on the display through the visible representation, and/or placement, and/or configuration, of said alphabetical keys and/or characters on said virtual keyboard locator unit.

As shown in FIG. 1, and/or FIG. 2, and/or FIG. 3, the alphabetical keys of the upper row (5), and/or the alphabetical keys of the lower row (6) of the virtual keyboard locator unit (3) can be preferably fully invisible, and/or at least partly invisible, to the user. Indeed, the alphabetical keys and/or characters appearing on said upper and/or lower alphabetical rows (such as key (14) of the upper row (5)) and/or key (16) of lower row (6)) of said virtual keyboard locator unit (3) can indicate (and/or help the user to locate) the invisible parts (and/or locations, and/or surface, and/or zones) of said alphabetical keys (such as invisible part (15) of key (14) and/or invisible part (17) of key (16)) on said display (2).

Also, according to the invention, if the invisible part of the upper row (and/or the partly visible part of said upper row), and/or if the invisible part of the lower row (and/or the partly visible part of said lower row) of the virtual keyboard locator unit are at least touched by the user's finger, without said finger touching the middle row, then at least one key of said upper row, and/or at least one key of said lower row can be preferably selected. As shown in the three figures mentioned above, if the upper row (5) and its invisible row part (12) (and/or the partly visible part of said upper row (5)), and/or if the lower row (6) and its invisible row part (13) (and/or the partly visible part of said lower row (6)), are at least touched by the user's finger, without said finger touching the middle row (4), then at least one key of said upper row (5), and/or at least one key of said lower row (6), can be preferably selected. According to the invention, the invisible part (and/or location, and/or surface, and/or zone) of the thin visible upper row, and/or of the thin visible lower row, can preferably be in the shape of an invisible large row of invisible large alphabetical keys situated and/or extending either near to, and/or contiguous to, and/or included at least in part of, the visible part of said upper and/or lower rows on the display.

Also, according to the invention, and as shown in FIG. 2, the three visible rows of alphabetical characters (and/or keys) of the virtual keyboard locator unit (3) can appear as being (at least substantially) comprised into one single, non-invasive, thin linear software window extending along at least one side of the display (2). In this patent application, the word “row” can preferably include in its definition a row of alphabetical characters having preferably a Qwerty arrangement (but please note that the principles disclosed in this application can also apply to any other type of alphabetical arrangements on said rows). The word “row” should not be necessarily understood as meaning that the rows of alphabetical characters of the preferred virtual keyboard locator units described in this application are necessarily limited (and/or surrounded) by visual horizontal (and/or vertical) border lines. The word “row” should also be understood as including rows of virtual alphabetical characters not surrounded by visible and/or virtual border lines.

According to the invention, at least one of the three alphabetical rows of keys and/or characters of a conventional Qwerty keyboard (and/or at least a substantial portion of said at least one row) can be assigned to at least one row of alphabetical keys and/or characters of the virtual keyboard locator unit.

As shown in FIG. 1, and/or FIG. 2, and/or FIG. 3, the three rows/levels (4), (5) and (6) of keys and/or characters of the virtual keyboard locator unit (3) are a representation of the three alphabetical rows of a conventional virtual Qwerty keyboard. Indeed, the characters and/or keys of the upper alphabetical row of a conventional virtual Qwerty keyboard are assigned to the keys of upper row (5). In the same manner, the characters and/or keys of the middle alphabetical row of a conventional virtual Qwerty keyboard are assigned to the keys of middle row (4). Finally, the characters and/or keys of the lower alphabetical row of a conventional virtual Qwerty keyboard are assigned to the keys of lower row (3).

Therefore, according to the invention, said three rows are arranged in a conventional order of three-row Qwerty keyboard alphabetical characters, and wherein:

a) a conventional middle row of Qwerty keyboard alphabetical characters is represented by the alphabetical characters of the middle row of said locator;
b) a conventional upper row of Qwerty keyboard alphabetical characters is represented by the alphabetical characters of the upper row of said virtual locator; and
c) a conventional lower row of Qwerty keyboard alphabetical characters is represented by the alphabetical characters of the lower row of said virtual keyboard locator.

According to the invention, and as shown in FIG. 2, the alphabetical characters of at least one of the three alphabetical rows of the virtual keyboard locator unit (for example, the alphabetical characters of the middle row (4) of the virtual keyboard locator unit (3)) can be preferably not surrounded by visible border lines separating them from the other rows of alphabetical characters of said unit. According to the invention, this specific design of the virtual keyboard locator unit (and/or this specific design of its rows of alphabetical characters) allows said unit to appear as thin as possible on the display (for example, on the display (2)), and/or to appear as one single, non-invasive, thin linear software window extending along at least one side of the display.

According to the invention, the visible images of the alphabetical keys and/or characters, of at least one of the rows of the virtual alphabetical keyboard locator unit, can be situated either near to, and/or contiguous to, and/or included at least in part of, the space and/or zone allocated on the display to the partly invisible and/or fully invisible alphabetical keys said visible virtual keys and/or characters are a representation of.

Indeed, and as shown in FIG. 1, and/or FIG. 2, and/or FIG. 3, the user preferably can select a key of the upper row (5), and/or a key of the lower row (6) by either: a) at least touching the visible image part of said key on the upper row (5) and/or on the lower row (6), and/or b) at least touching the invisible part assigned to said key on the display (2).

According to the invention, at least one of the rows of alphabetical keys and/or characters of the virtual keyboard locator unit can be considered, preferably and additionally, as a fully active alphabetical keyboard row, having at least part of the keys and/or characters appearing on it as being fully active data entry keys.

Indeed, and as shown in FIG. 1, and/or FIG. 2, and/or FIG. 3, the keys of the middle row (4) of the virtual keyboard locator unit (3) can be preferably considered as fully active data entry keys. Indeed, the keys of said middle row (4) can be preferably visible in their entirety on the display (2) of the device (1). The keys of said middle row (4) can be named fully active keys, also because they preferably do not act as key locators, and/or because they preferably can be visible in their entirety on the display, especially in the instances of FIG. 1 and FIG. 2, where the spacing between the middle row (4) and the two other external rows (5) and (6) is very limited.

It is possible that the keys of the middle row of the virtual keyboard locator unit may not have any invisible part on the display, and/or may act preferably as regular and/or conventional virtual keys. Also, the virtual keyboard locator unit (3) can additionally be considered as a partly visible virtual keyboard having preferably, and as a consequence, a thin shape since its middle row may be preferably fully visible, and its two external rows (upper row (5) and/or lower row (6)) may be preferably partly invisible.

As a consequence, and according to the invention, the middle row of the virtual keyboard locator unit can be preferably a fully active row of keys, whereas the upper and lower external rows of said unit can be preferably partly invisible, and/or fully invisible, rows of keys which can act as key locators.

According to the invention, a key of the middle alphabetical row can be preferably selected in priority over a key of any other external alphabetical row if any visible part (and/or surface) of the virtual keyboard locator unit is at least touched by the user's finger. In this instance, a key of the middle alphabetical row located on (and/or closely located to) the surface (and/or zone) touched by said user's finger on the virtual keyboard locator unit can be preferably selected as long as any visible part (and/or surface) of the virtual keyboard locator unit is at least touched by the user's finger (and this is true even if any surface (visible and/or invisible) of the two external rows of keys and/or characters of said unit is touched by said user's finger).

According to the invention, if the user's finger at least touches the middle row, then a key of said middle row located on (and/or closely located to) the surface (and/or zone) touched by said finger on said middle row can be preferably selected (and this is true even if any surface and/or zone (visible and/or invisible) of the two external rows of keys and/or characters of said unit is also touched by said user's finger).

According to the invention, if the user's finger at least touches a surface (and/or zone) on the display that is assigned to the upper row of the virtual keyboard locator unit, and if said surface (and/or zone) touched by the user's finger is outside of the visible surface of the center row, and/or if said finger does not touch said visible center row, then the user can be preferably selecting a key of the upper row, preferably located on (and/or closely located to) said touched surface (and/or zone). In the same manner, if the user's finger at least touches a surface (and/or zone) on the display that is assigned to the lower row of said virtual keyboard locator unit, and if said surface (and/or zone) touched by the user's finger is outside of the visible surface of the center row, and/or if said finger does not touch said visible center row, then the user can be preferably selecting a key of the lower row, preferably located on (and/or closely located to) said touched surface (and/or zone).

According to the invention, if the user's finger at least touches a surface (and/or zone) on the display that is assigned to the upper row of the virtual keyboard locator unit, and if said surface (and/or zone) touched by the user's finger is outside (and/or substantially outside) of the surface of the visible virtual keyboard locator unit, and/or if said finger does not touch said visible keyboard locator unit, then the user can be preferably selecting a key of the upper row preferably located on (and/or closely located to) said touched surface (and/or zone). In the same manner, if the user's finger at least touches a surface (and/or zone) on the display that is assigned to the lower row of said virtual keyboard locator unit, and if said surface (and/or zone) touched by the user's finger is outside (and/or substantially outside) of the surface of the visible virtual keyboard locator unit, and/or if said finger does not touch said visible virtual keyboard locator unit, then the user can be preferably selecting a key of the lower row preferably located on (and/or closely located to) said touched surface (and/or zone).

In a general manner, and according to the invention, the user can be selecting the characters of the middle row by at least touching a visible part of the very thin virtual keyboard locator unit, and/or by touching at least part of a zone in proximity, and/or along, and/or around, a visible part of said unit. Indeed, and according to the invention, the keys of the middle row of the thin keyboard locator unit are only preferably fully visible, but it should be in no way understood in this invention that said keys of the middle row are necessarily fully visible. According to the invention, it is perfectly possible to imagine that the zones and/or surfaces of selection, of said keys of the middle row, slightly extend invisibly beyond the visible parts of the thin linear keyboard locator unit, for example in the instance of a very thin virtual keyboard locator unit. In this instance for example, we can imagine that the zones and/or surfaces of selection of the external upper row and/or lower row can be located further away on the display from said visible parts of the unit.

According to the invention, a virtual Qwerty keyboard unit preferably not comprising, and/or showing, any alphabetical key and/or character on it, and showing preferably only a thin line representing the middle alphabetical row of a virtual Qwerty keyboard unit. According to said invention, if the user's finger touches said middle row, then the system preferably selects an alphabetical key on said middle row (preferably an alphabetical key usually/conventionally located on the surface (and/or zone) touched by said finger, and/or usually/conventionally located in proximity to said touched surface and/or zone). Also, if the user's finger does not touch said middle row and touches a surface (and/or zone) on the display above it, then the system preferably selects an alphabetical key of the upper row (preferably an alphabetical key usually/conventionally located on the surface (and/or zone) touched by said finger, and/or usually/conventionally located in proximity to said touched surface and/or zone). And, if the user's finger does not touch the middle row and touches a surface (and/or a zone) on the display below it, then the system preferably selects an alphabetical key of the lower row (preferably an alphabetical key usually/conventionally located on the surface (and/or zone) touched by said finger, and/or usually/conventionally located in proximity to said touched surface and/or zone). This minimalist user interface works preferably with (and/or at least with) an ambiguous text entry system (for example, a word predictive text entry system). The text entry system can also analyze the overall shape of the locations on the screen touched by the user's finger in order to predict which word said user intends to enter. According to the invention, the visible middle row line brings additional and helpful information to the system by defining precisely, at any time, if the user's finger touches an alphabetical key on the middle row, and/or an alphabetical key on the upper row, and/or an alphabetical key on the lower row. This virtual Qwerty keyboard unit is preferably represented by only one thin line which is the least invasive as possible.

According to the invention, a virtual Qwerty keyboard unit having three rows of alphabetical keys and/or characters, and wherein if a user's finger only touches an alphabetical key appearing on said unit, then the user preferably selects preferably an alphabetical key of the middle row of said unit. Also, if the user's finger touches an alphabetical key appearing on said unit, and then slides and/or swipes its finger upward, then the user preferably selects an alphabetical key of the upper row of said unit. And, if the user's finger touches an alphabetical key on said unit, and then slides and/or swipes its finger downward, then the user preferably selects an alphabetical key of the lower row of said unit. An alphabetical key appearing on said virtual keyboard locator unit preferably shows alphabetical characters of the middle, and/or lower, and/or upper rows.

According to the invention, the three rows of alphabetical keys and/or characters of the virtual Qwerty keyboard locator unit have preferably different colors. In particular, the middle (and/or center) row preferably comprises alphabetical keys and/or characters which appear in a different color than the alphabetical keys and/or characters of the upper and/or lower external alphabetical rows. This difference in color is done at least in order to clearly and visually distinguish the middle (and/or center) row from the two other upper and lower external rows. Indeed, this difference in color is done in order to help the user understand intuitively that, in order to select any external alphabetical key of the upper and/or lower rows, said user has to touch with its finger (and/or select by any other possible means) a surface (and/or a zone) on the display (said surface being preferably precisely indicated by a key locator) which is located outside the visible and differentiated surface of the middle (and/or center) row.

According to the invention, the external upper and lower alphabetical rows of keys and/or characters have keys and/or characters which have preferably (but not necessarily) the same color to clearly distinguish themselves from the keys and/or characters of the middle (and/or center) row, in order to make the user intuitively understand (and/or see) that in order to select an alphabetical key on the middle (and/or center) row, said user has to touch the surface (and/or zone) where said key appear on said middle (and/or center) row, and b) in order to select an alphabetical key of the upper and/or lower external rows, said user has to touch the surface (and/or zone) where said key appears (and/or is indicated/located) on said upper and/or lower rows, and said surface (and/or zone) is outside of said middle (and/or center) row. In fact, the difference in color increases the user's speed of typing by clearly setting apart, through a different color, the alphabetical keys and/or characters of the middle (and/or center) row. According to this invention, at least the upper and lower external rows of alphabetical keys and/or characters preferably appear on a see-through background in order: 1) to make the virtual keyboard locator unit appear thinner in appearance, and 2) to increase the user's intuitive feeling that the alphabetical keys of said upper and lower external rows are partly and/or fully invisible.

Therefore, according to an embodiment of the invention, the visible alphabetical characters of said middle row have a color different from a color of the visible alphabetical characters of said upper row and/or said lower row in order to provide an intuitive visual separation effect between said three rows.

According to the invention, the virtual Qwerty keyboard locator unit is preferably designed in the shape of a thin rectangular software window unit, and/or in the shape of a thin rectangular band and/or thin rectangular row. According to the invention, this design in the shape of a thin rectangular software window unit is possible in part because the upper and lower external rows of alphabetical keys and/or characters preferably have a thin visible linear shape due to the fact that they are partly invisible and/or fully invisible on the display.

Consequently, and according to the invention, the software window of the virtual keyboard locator unit is preferably designed in the shape of a thin rectangle, and wherein said thin rectangular software window design can additionally be used to show, and/or display, advertisement images in the shape and/or format of a conventional rectangular ad banner for smart phone devices and/or mobile telecommunication devices.

According to the invention, this ad banner appearing in the rectangular software window of the keyboard locator unit, can show advertisement images (and/or advertisement links) preferably (but not necessarily) relating to keywords entered previously by the user when using said same rectangular software window as an alphabetical keyboard locator unit. According to the invention, said software window of a virtual Qwerty keyboard locator unit can be preferably designed in the shape of a conventional rectangular ad banner for smart phones and/or mobile telecommunication devices.

According to the invention, the software window of said virtual Qwerty keyboard locator unit, preferably designed in the shape of a conventional rectangular ad banner for smart phones and/or mobile telecommunication devices, can comprise at least one key, and/or can respond to at least one type of input signal (for example: a finger touch, and/or a finger slide, on and/or outside the visible surface of said unit on the display), in order to open it, and/or extend it, when the image of an ad banner appears on it. The extension, and/or opening, of said thin rectangular software window displaying an ad banner preferably results in the user being directed to a web page relating to a product, (and/or a service, and/or an entity) being advertised on said ad banner.

Moreover, and according to the invention, said ad banner for smart phones and/or mobile telecommunication devices, can comprise additionally at least one key, and/or can respond to at least one type of input signal (for example: a finger touch, and/or a finger slide, on and/or outside the visible surface of said unit on the display) in order to make the image of a Qwerty keyboard locator unit (and/or the image of a thin Qwerty keyboard unit in the approximate shape and/or size of a conventional ad banner for smart phones) appear again (instead of the image of an ad banner) on said software window having a thin rectangular shape.

As a consequence, the thin rectangular, non-invasive software window of the ad banner can remain on the screen at all times, preferably as long as the user does not close it, and/or preferably as long as the user does not use said software window as a virtual keyboard locator (and/or virtual keyboard) unit.

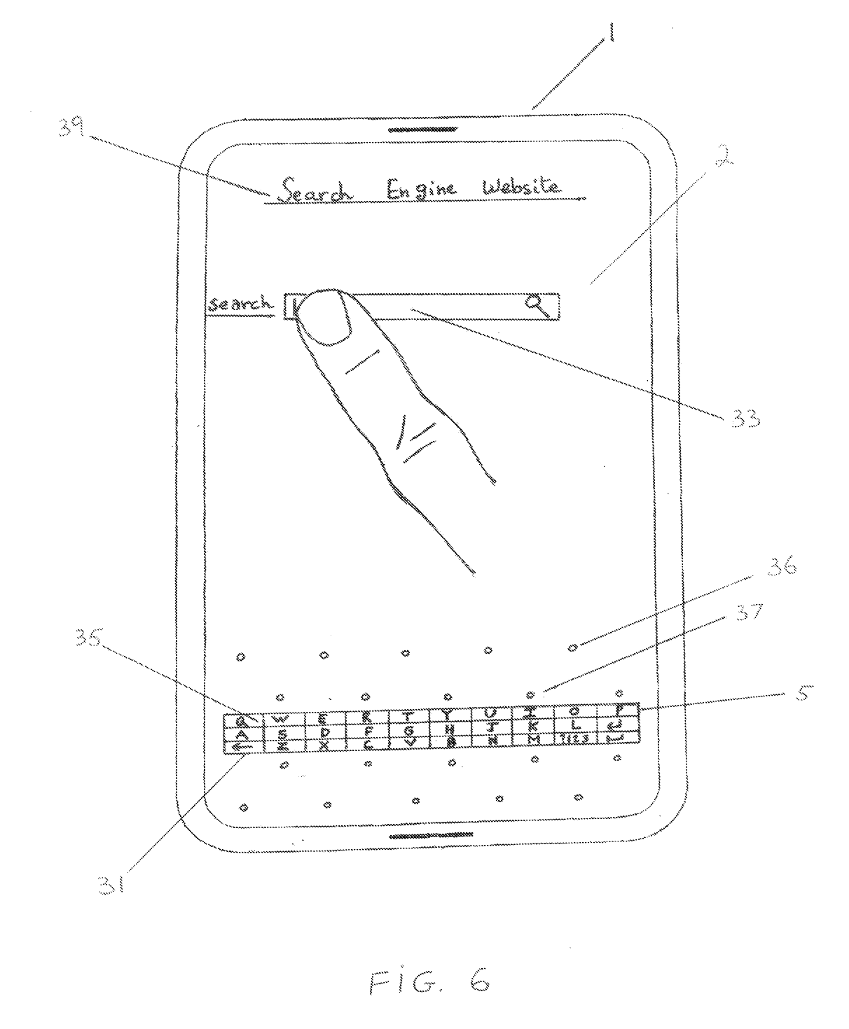

According to the invention, an advertisement image appearing in a conventional rectangular ad banner for smart phones, is replaced by an image of a virtual keyboard locator (and/or a virtual keyboard) unit at least as a result of an input signal from the user at least selecting a software window on the display whose function is to provide a space on the display for typing and/or entering a word and/or a text, and/or as a result of any input signal to enter text on any software application on the display. For example, and as shown in FIG. 6, an advertisement image appearing in a conventional rectangular software window of ad banner (35) which appears itself on the mobile web page (39) of a search engine website, is replaced by the image of a virtual keyboard locator unit (31) after the user selects (preferably with its finger) the software window (33) for entering a keyword to be searched on the search engine.

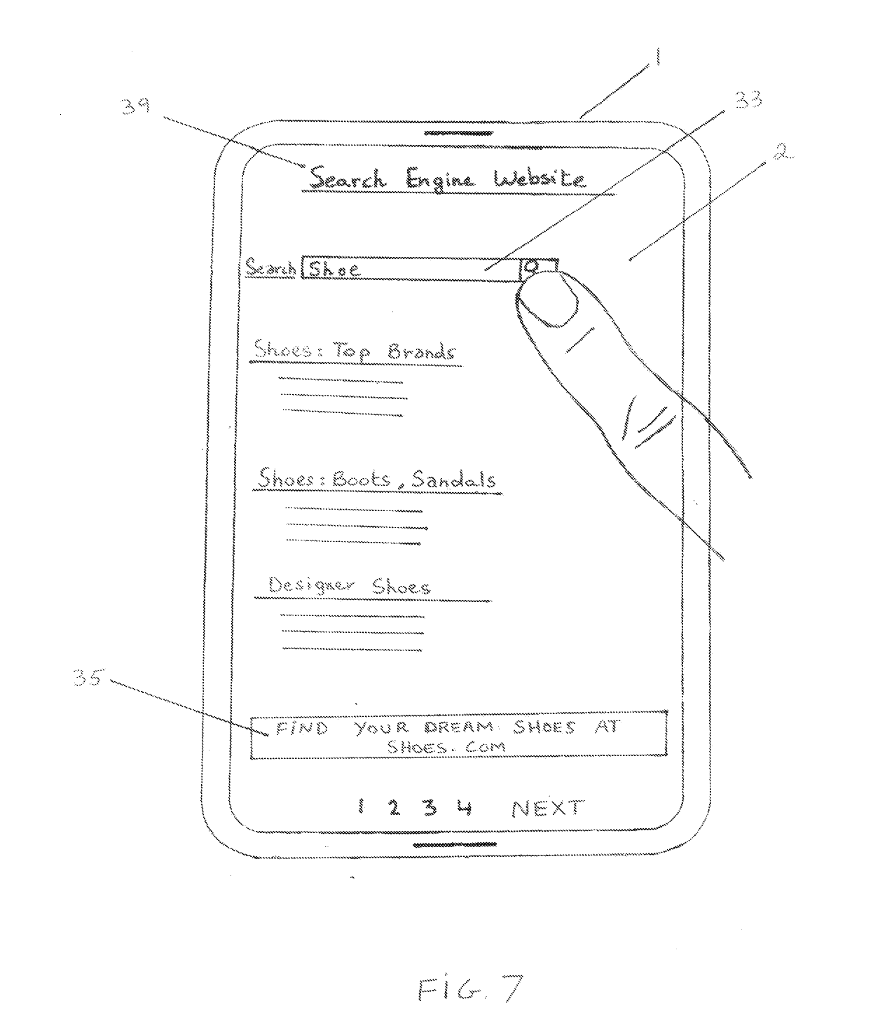

Conversely, and according to one embodiment of the invention, an advertisement image, preferably (but not necessarily) relating to a keyword entered, replaces an image of a virtual alphabetical keyboard locator (and/or a virtual keyboard) appearing in a thin rectangular software window at least after the user types and/or enters a word and/or a text in a software window whose function is to provide a space on the display for typing and/or entering a word and/or a text. For example, and as shown in FIG. 7, the thin rectangular software window (35) displays an advertisement image relating to the keyword “shoe” typed and/or entered by the user using previously said same thin rectangular software window as a virtual keyboard locator (and/or virtual keyboard) unit.

According to the invention, a thin rectangular software window, having a conventional ad banner shape, for either: a) supporting the image of a thin virtual alphabetical keyboard (and/or virtual alphabetical keyboard locator) having a conventional ad banner shape, and/or b) for subsequently advertising, in a conventional ad banner format, images relating at least to keywords entered previously using the image of the virtual keyboard (and/or virtual keyboard locator) displayed previously in said thin rectangular software window.

According to the invention, a conventional rectangular ad banner for a touch screen smart phone device, which becomes a virtual keyboard locator (and/or a virtual keyboard) unit, as a result of an input signal from the user selecting a software window on the display whose function is to provide a space on the display for typing and/or entering a word and/or a text. According to the invention, a virtual keyboard locator (and/or virtual keyboard) in the shape of a thin conventional rectangular ad banner which becomes an actual ad banner as a result of a user typing and/or entering a word and/or a text on its mobile telecommunication device.

According to the invention, the surface (and/or zone) on the display of the partly invisible and/or fully invisible alphabetical keys, and/or row of keys, of the virtual Qwerty keyboard locator unit extends along both sides of said virtual Qwerty keyboard locator unit comprising at least three rows of alphabetical keys and/or characters arranged preferably in a conventional Qwerty order.

As shown in FIG. 1, and/or FIG. 2, and/or FIG. 3, the keys of the upper row (5), and/or the keys of the lower row (6) of the virtual Qwerty keyboard locator unit (3) are fully invisible, and/or at least partly invisible, to the user. Indeed, the surfaces (and/or zones) on the display of partly invisible and/or fully invisible alphabetical keys (such as invisible part (15) of key (14) and/or invisible part (17) of key (16)), and/or row of keys (such as invisible row part (12) of upper row (5), and/or invisible part (13) of lower row (6)), extend along both sides of the virtual Qwerty keyboard locator unit (3).

According to the invention, at least one row of visible alphabetical keys and/or characters of the virtual Qwerty keyboard locator unit can be a thin and elongated visible portion of a partly invisible and/or fully invisible conventional alphabetical row of keys of a virtual Qwerty keyboard unit on the display.

As shown in FIG. 1, and/or FIG. 2, and/or FIG. 3, the visible keys and/or characters of the thin and elongated upper row (5), and/or the visible keys and/or characters of the thin and elongated lower row (6), of the virtual keyboard locator unit (3), are the thin and elongated visible portions of the partly invisible and/or fully invisible conventional alphabetical upper and lower rows of keys (12) and (13) of a conventional virtual Qwerty keyboard unit on the display (2).

According to the invention, the thin, and/or non-invasive, shape of the virtual Qwerty keyboard locator unit results at least from the fact that its upper and/or lower rows are preferably partly invisible and/or fully invisible on the display (2).

According to the invention, basic and/or often used text entry command keys such as the “Space” key and/or the “Backspace” key can preferably be located (and/or comprised) at least either:

1) on the virtual keyboard and/or keyboard locator unit, and/or on at least one of the three alphabetical rows of the virtual Qwerty keyboard locator unit. As shown in FIG. 1 and/or FIG. 2, “Space” key locator (11) and “Backspace” key locator (10) can be located on lower row (6), and/or on the sides of the virtual Qwerty keyboard locator unit.

2) anywhere on the display. As shown in FIG. 3, “Space” key locator (11) and “Backspace” key locator (10) are located respectively on a portion of the right and left edges of the display (2). According to the invention, the invisible part of at least one alphabetical character and/or command indicated on a keyboard locator row can be located further away on the display than the invisible part of at least one other alphabetical character and/or command indicated on said same keyboard locator row. Indeed, and according to the invention, the invisible parts of the alphabetical characters (and/or commands, and/or function) of one keyboard locator row are not necessarily located on the same invisible level on the display. Indeed, some can be located further away than others from their visible row.

Consequently, and as shown in FIG. 1 and/or FIG. 2, the invisible parts of the “Space” and “Backspace” keys (18) and (19) can be located further away than the invisible parts of other alphabetical keys located on the same lower row (6). The further away invisible locations of said basic command keys are advantageous at least for the few following reasons:

1) They allow said invisible parts to expand on the display in larger dimensions and be more comfortable to use by the user. For example, the further away length of the invisible part (18) of the “Space” key can be approximately equal to half of the length (on the right side) of the virtual keyboard locator unit (3), and/or the further away length of the invisible part (19) of the “Backspace” key can be approximately equal to half the length (on the left side) of the virtual keyboard locator unit (3);

2) They avoid any instances of mistyping with other alphabetical keys whose visible parts are located next to the visible parts of said basic commands; c) They allow more space to be available on the display for the user to make appear and/or select additional commands, and/or function, and/or punctuation, and/or symbols, and/or numbers from said basic command keys (the way the user can make them appear, and/or select them, is in described in detail below on pages 9 and 10).

According to the invention, a user can see (and/or intuitively understand) that the invisible part of an alphabetical key and/or command is located further away than the invisible part of another alphabetical key and/or command located on the same visible row, preferably through the visible specific, distinct and/or different representation and/or arrangement of said alphabetical key and/or command on its visible row locator.

For example, a key whose invisible part is located further away on the display can appear slightly higher than other keys on its visible row locator. Also, according to the invention, and as shown in FIG. 6, additional key locator instruments can appear on the display, in order to show to the user, the partly invisible (and/or fully invisible) locations on said display, of keys which are located either further away from, and/or closer to, their respective keyboard locator row. For example, and as shown in FIG. 6, the additional key locator instrument (37) (shaped in the instance as a non-invasive, small, see-through dot) indicates to the user, on which location (and/or level) on the display is at least located the partly invisible (and/or fully invisible) part of the alphabetical key (I).

For example, and as shown in FIG. 6, the additional key locator instrument (36) (shaped in the instance as a non-invasive, small, see-through dot) indicates to the user, on which location (and/or level) on the display is at least located the partly invisible (and/or fully invisible) part of the alphabetical key (O). As shown in FIG. 6, the additional key locator instrument (37) indicates that the partly invisible (and/or fully invisible) part of the alphabetical key (I) is at least located closer to its respective keyboard locator row (such as upper row (5)) than the partly invisible (and/or fully invisible) part of the alphabetical key (O) which is at least located further away from its same respective keyboard locator row (such as upper row (5)) as it is indicated by its additional key locator instrument (36).

According to the invention, additional key locator instruments can take any shape, form, size, and can be located (and/or appear) anywhere on the display. These additional key locator instruments can be additional key locator instruments to at least alphabetical keys, and/or command keys, and/or function keys, and/or symbol keys, and/or number keys, whose locations (visible and/or invisible) on the display are already indicated by their respective keyboard locator row.

According to the invention, and as shown in FIG. 3, these basic and often used text entry command keys can preferably be at least partly invisible, and/or fully invisible, on the display. Indeed, these command keys, such as the “Space” key (11) and/or the “Backspace” key (10), can preferably be partly invisible and/or fully invisible virtual keys located preferably toward the center of display (such as display (2)), preferably away from the location on said display of the virtual keyboard locator unit (such as unit (3)).

As a consequence, these command keys have larger dimensions, which is practical since they are often used by the user. Moreover, the alphabetical keys of the virtual keyboard locator unit (such as unit (3)) can have larger dimensions, and said virtual keyboard locator unit can be thinner because of the free space left by these commands keys being located somewhere else on the display.

According to the invention, the invisible location of any of said basic command on the display is preferably indicated by a visible key locator (such as key locator (9)) which is preferably the partly visible portion of the partly invisible “Space” key (11) of FIG. 3.

According to the invention, the “Space” command of the virtual keyboard locator unit can be entered through a slide of the user's finger preferably toward the right side of the display.

According to the invention, this slide of the user's finger can start from anywhere on the display. Indeed, it can start either: 1) outside the visible surface of the virtual keyboard locator unit in the shape of a thin rectangular band, and/or 2) inside the visible surface of the virtual keyboard locator unit in the shape of a thin rectangular band. In this instance, the “Space” command preferably does not have a visible key assigned to it on the virtual keyboard locator unit. Also, according to the invention, at least one software window, which can offer to the user the choice to select additional commands, and/or function, and/or punctuation, and/or symbols, and/or numbers can open, preferably through the user performing any type of input signal from and/or on the visible and/or invisible parts of said “Space” command keys.

A type of possible input signal can be for example: the user's finger touching a visible and/or invisible surface/part/zone of said “Space” command key for a specific amount of time, and/or for example: the user performing a swipe movement with its finger from a zone on the display assigned to said “Space” key toward at least one direction, and then preferably holding its finger on the display for a specific time period.

Examples of additional commands and/or function to select from can be: shifting to a virtual numerical keyboard, and/or selecting the “Enter” key, and/or selecting a dot or a question mark punctuation. According to the invention, these additional commands, and/or punctuation/symbols, can be selected preferably through any additional input signal, preferably for example: a directional slide of the user's finger toward, and/or a touch of the user's finger on, the images on the display of said additional commands and/or punctuation/symbols.

According to the invention, the “Backspace” command of the virtual keyboard locator unit can be entered through a slide of the user's finger preferably toward the left side of the display. According to the invention, this slide of the user's finger can start from anywhere on the display. Indeed, it can start either: 1) outside the visible surface of the virtual keyboard locator unit in the shape of a thin rectangular band, and/or 2) inside the visible surface of the virtual keyboard locator unit in the shape of a thin rectangular band. In this instance, the “Backspace” command preferably does not have a visible key assigned to it on the virtual keyboard locator unit.

Also, according to the invention, at least one software window, which can offer to the user the choice to select additional commands, and/or function, and/or punctuation, and/or symbols, and/or numbers can open, preferably through the user performing any type of input signal from and/or on the visible and/or invisible parts of said “Backspace” command keys.

A type of possible input signal can be for example: the user's finger touching a visible and/or invisible surface/part/zone of said “Backspace” command key for a specific amount of time, and/or for example: the user performing a swipe movement with its finger from a zone on the display assigned to said “Backspace” key toward at least one direction, and then preferably holding its finger on the display for a specific time period. Examples of additional commands and/or function to select from can be: shifting to a virtual numerical keyboard, and/or selecting the “Enter” key, and/or selecting a dot or a question mark punctuation.

According to the invention, these additional commands, and/or punctuation/symbols, can be selected preferably through any additional input signal, preferably for example: a directional slide of the user's finger toward, and/or a touch of the user's finger on, the images on the display of said additional commands and/or punctuation/symbols.

According to the invention, a slide movement of the user's finger, starting inside and/or outside the surface of any virtual keyboard locator unit (and/or virtual keyboard unit) described in this patent application, and going toward an upward and/or downward direction, can result in an input signal resulting in the input of, and/or in the appearance of a software window showing to the user, at least one punctuation (for example: a dot and/or a coma punctuation), and/or at least one symbol (for example: the “@” symbol), and/or at least one command (for example: the “Enter” command), and/or at least one function (for example: a numerical keyboard shift function), to select from. For example, a slide movement of the user's finger, starting inside and/or outside the surface of a virtual keyboard locator unit, and going toward a downward direction, can at least result in an input signal resulting in the input of the “Enter” command.

FIG. 1 shows three conventional alphabetical rows of a Qwerty keyboard attached, and/or touching, and/or contiguous to each other. Each, and/or at least one, of these three alphabetical rows can be preferably in the shape of a very thin line. The alphabetical characters comprised in said at least one very thin line can be preferably and approximately of the smallest visible size to be comfortably readable by majority of users on the market. The border lines of said at least one very thin row can have a height which is approximately equal to height of the alphabetical characters they surround.

According to the invention, these at least three thin and/or very thin rows of alphabetical characters and/or keys preferably can form together a software window preferably in shape of a thin rectangular band, and/or in the shape of a thin rectangular row. The middle row (such as middle row (4)) can be preferably visible in its entirety. The surface of the upper row (such as upper row (5)) can be preferably only partly visible by the user on the display (such as display (2)). Indeed, the upper row can be preferably the visible portion, in the shape of a thin line, of a larger invisible upper row of keys on the display (such as invisible upper row (12)). The surface of the lower row (such as lower row (6)) can be preferably only partly visible by the user on the display. Indeed, the lower row can be preferably the visible portion, in the shape of a thin line, of a larger invisible lower row of keys on the display (such invisible lower row (13)).

FIG. 2 shows a virtual Qwerty keyboard locator unit (3) in the shape of a thin band, and/or in the shape of a row, and/or in the shape of a thin rectangular software window. According to the invention, this row and/or thin rectangular software window (3) comprise (at least) the three conventional rows of alphabetical characters of a Qwerty keyboard, such as the middle alphabetical row (4) and the two other alphabetical external rows which are upper row (5) and lower row (6).

According to the invention, said three visible rows of alphabetical characters (and/or keys) of the virtual keyboard locator unit can be preferably (and/or at least substantially) comprised into one single, non-invasive, thin linear software window (and/or row), extending along at least one side of the display.

According to the invention, the alphabetical characters of at least one of said three alphabetical rows of the virtual keyboard locator unit are preferably not surrounded by visual border lines (for example, middle row (4)).

Moreover, and according to the invention, at least part of the images of the alphabetical characters of the upper and/or lower rows can appear, and/or can be at least substantially, at same level than the images of the alphabetical characters of middle row. But, and according to the invention, the user can still visually distinguish in a clear, and/or quick, and/or intuitive manner, the middle row of alphabetical characters from the two other external rows of alphabetical characters. Indeed, and according to the invention, the alphabetical characters of the middle row can have preferably a unique color which sets them apart from the alphabetical characters of the upper and/or lower external rows which can have preferably a color which is different from the one of the middle row.

This coloring difference creates a visual, and/or intuitive, separation effect between the middle row of alphabetical characters and the other two external alphabetical rows. These three rows of alphabetical characters can be, as a consequence, clearly and/or visually set apart from one another, even if they extend together on a narrow surface (and/or zone) preferably along one side of the display.

According to the invention, this specific colored representation of said three rows of alphabetical characters of the virtual keyboard locator unit, and/or the specific manner (and/or arrangement, and/or design) in which the alphabetical characters of the upper and/or lower rows insert themselves (at least substantially) in the middle row, and/or the specific manner in which they can insert themselves and/or appear (at least substantially) between, and/or on, the alphabetical characters of said middle row, allows said virtual keyboard locator unit to appear as thin as possible on the display, and/or to appear as one single, non-invasive, thin linear software window extending preferably along at least one side of the display.

According to the invention, at least two virtual alphabetical characters belonging to at least two different alphabetical rows of said conventional virtual Qwerty keyboard locator unit (such as unit (3) of FIG. 2) can appear on the display as if at least part of the image of at least one of said alphabetical character is located (and/or inserts itself) on the image of the other alphabetical character. According to the invention, this design of a virtual Qwerty keyboard unit in the shape of a row, and/or a thin rectangular software window, can be also advantageous on an ergonomic level. Indeed, it becomes easier for the user's finger to move, and/or travel, the shortened distance between the upper row and the lower row.

Thus, it becomes easier for the user to select any alphabetical characters of these external rows with more precision, and/or accuracy, and/or speed. Also, the thinner the virtual alphabetical unit, the less invasive it is on the display, and the less it obstructs, and/or blocks, the view of other background images on the display.

Also, and according to the invention, a virtual keyboard locator unit (and/or virtual keyboard unit) comprising at least three rows of alphabetical characters, and wherein the alphabetical characters of the middle row are designed differently from the alphabetical characters of the upper and/or lower rows, in order to allow the user to quickly, and/or visually, and/or intuitively, distinguish said middle row of alphabetical characters, and as a consequence to quickly distinguish each one of said three rows of alphabetical characters. For example, the alphabetical characters of the middle row can be designed with larger dimensions, and/or with a different font, than the ones of the upper and/or lower rows.

According to the invention, the virtual Qwerty keyboard locator unit (such as unit (3)) and/or its at least three rows of alphabetical characters, can have, and/or can take, the shape of a thin rectangular band and/or row, without the need to have a visible peripheral border line (such as peripheral line (30)) extending around, and/or surrounding, said unit in a rectangular shape. Moreover, the thin rectangular software window (3) comprising (at least) the three conventional rows of alphabetical characters of a Qwerty keyboard can be see-through.

FIG. 3 shows the three usual alphabetical rows of a virtual Qwerty keyboard slightly separated from each other. Each, and/or at least one, of these three rows of alphabetical keys and/or characters can be preferably in the shape of a very thin line. The alphabetical characters comprised in said at least one very thin line can be preferably, and approximately, of the smallest visible size to be comfortably readable by majority of users on the market. The border lines of said at least one very thin row can have a height which is approximately equal to height of the alphabetical characters they surround.

According to the invention, these at least three thin, and/or very thin, rows of alphabetical characters and/or keys of the virtual keyboard locator unit can form together the shape of a thin rectangular software window and/or band. The middle alphabetical row (such as middle row (4)) can be preferably visible in its entirety, and/or can additionally at least expand invisibly on, and/or along, a substantial portion of the separation zones (such as (7) and (8)) which can extend on a surface on the display going from both sides of the middle alphabetical row up to the visible portion of the upper and/or lower alphabetical rows (such as rows (5) and (6)).

The upper alphabetical row (5) can be preferably only partly visible. Indeed, the upper alphabetical row (5) can be preferably the visible portion in the shape of a thin line of a larger invisible upper row of alphabetical keys (12) on the display. The lower alphabetical row (6) can be preferably only partly visible. Indeed, the lower alphabetical row (6) can be the visible portion in the shape of a thin line of a larger invisible lower row of alphabetical keys (13) on the display.

According to the invention, a key and/or an alphabetical character of the upper row can be preferably selected if: 1) the user's finger does not touch a key and/or an alphabetical character of the middle row, and 2) the user's finger touches a surface (and/or a zone) on the display above said middle row. In the same manner, and according to the invention, a key and/or an alphabetical character of the lower row can be preferably selected if: 1) the user's finger does not touch an key and/or an alphabetical character of the middle row, and 2) the user's finger touches a surface (and/or a zone) on the display below said middle row.

Moreover, and according to the invention, the exact/precise alphabetical character selected can be preferably the one whose image on the display is included in, and/or is the closest to, the surface (and/or zone) on said display touched by the user's finger. But, any type of auto-correction system, and/or any type of ambiguous text entry system (such as for example: any type of predictive text entry system), could decide to select another alphabetical character if it considers that said other alphabetical character was actually the one that the user intended to select at first.

According to the invention, a mobile telecommunication device having a display on which appears the image of an alphabetical keyboard unit, said image of an alphabetical keyboard unit (and/or a virtual alphabetical keyboard unit) comprising, on at least one side of the display, at least one non-invasive row of alphabetical keys and/or characters extending in the shape of a thin and/or very thin elongated line.

According to the invention, a thin and/or very thin, non-invasive, elongated linear row of alphabetical keys and/or characters can be defined as one preferably comprising: 1) alphabetical characters whose size is approximately equal to the smallest possible size for said characters to be readable comfortably by a majority of users, and 2) keys comprising said alphabetical characters having said smallest readable size and whose height is approximately equal to the height of said alphabetical characters.

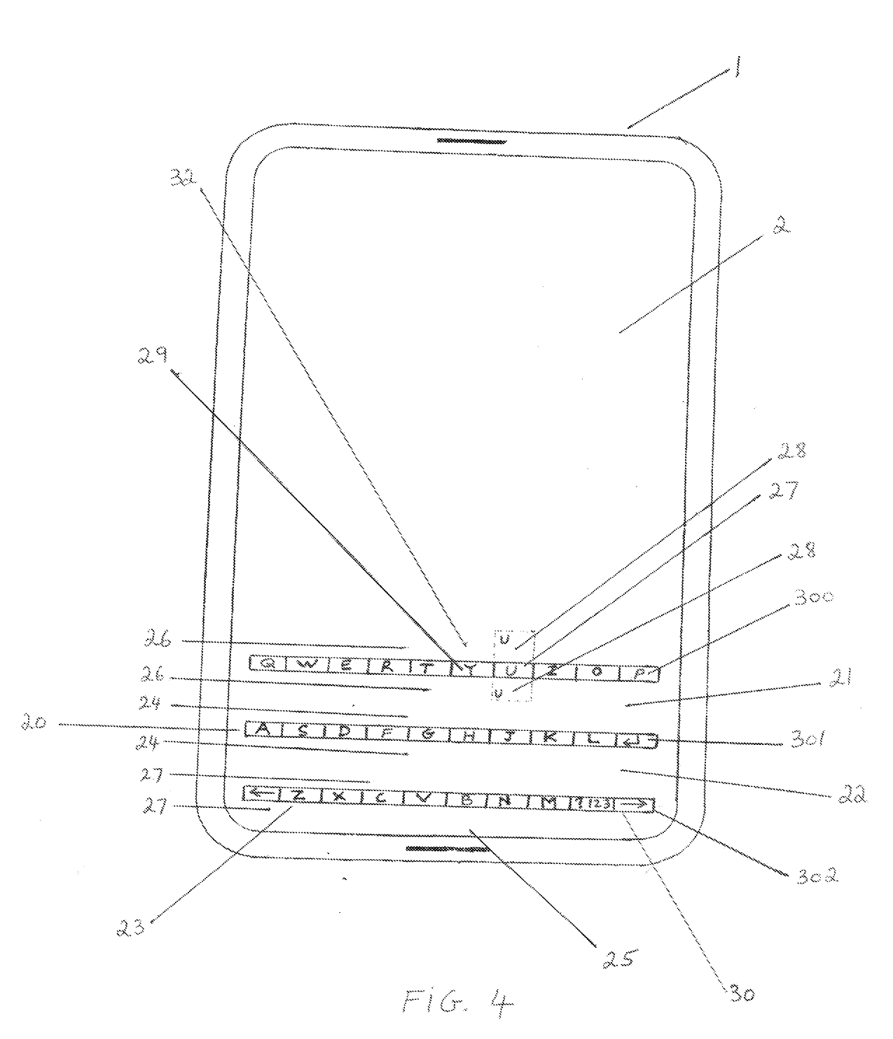

As shown in FIG. 4, a virtual alphabetical keyboard unit (23) appears on the display (2) of the smart phone device (1). Said virtual alphabetical keyboard unit (23) at least comprises the three conventional alphabetical rows of keys and/or characters of a conventional Qwerty keyboard. Each of said three alphabetical rows extends in the shape of a very thin elongated and/or non-invasive line, on and/or along one side (25) of the display (2). Each of said three very thin, non-invasive, elongated linear row of alphabetical keys and/or characters (namely rows (300), (301) and (302)) comprises alphabetical characters whose size appear as approximately equal to the smallest possible size for said characters to be readable comfortably by a majority of users. Also, the height of the keys (for example: the height of key (29)), and/or the height of the rows of keys (for example: the height of upper row (300)), comprising said alphabetical characters is approximately equal to the height of said alphabetical characters.

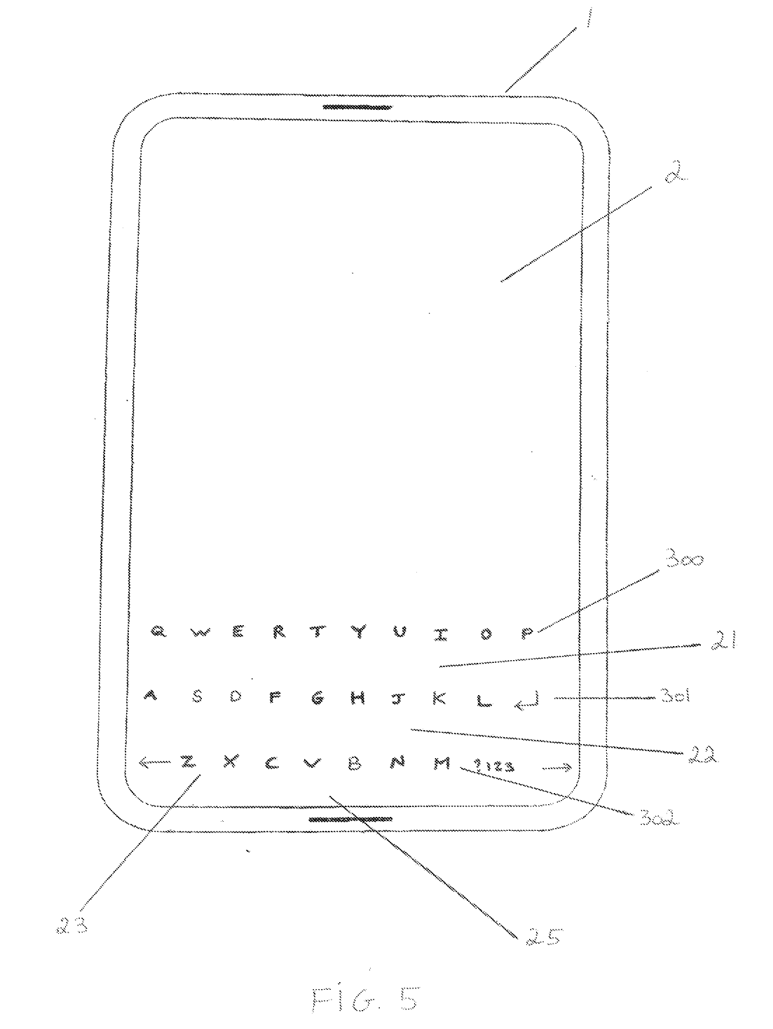

According to the invention, and as shown in FIG. 5, the virtual keyboard unit (23) at least comprises three very thin rows of alphabetical keys and/or characters (such as upper, middle and lower rows (300), (301) and (302)). Said very thin, and/or non-invasive, alphabetical rows are not surrounded by any visible border and/or limit lines. The thin and/or very thin elongated linear shape of said alphabetical rows is made at least from the following characteristics: a) the images of said characters following each other in a linear manner, and b) said characters having a size which is approximately equal to the smallest size possible size for said characters to be readable by a majority of users.

As shown in FIG. 4 and/or in FIG. 5, the visible rows of alphabetical keys and/or characters of the virtual keyboard unit (23) are very thin and non-invasive on the display (2). As a consequence, and according to the invention, the particular design of said alphabetical rows results in the creation of substantial and/or large, empty and/or transparent spaces (and/or zones) between said alphabetical rows (such as (21) and (22)) allowing the user to see the background images of any other application on the display.

According to the invention, at least one of the three alphabetical rows of a conventional Qwerty keyboard can be assigned to said at least one thin, and/or very thin, row of alphabetical keys and/or characters of the virtual keyboard unit.

As shown in FIG. 4, the virtual Qwerty keyboard (23) is made at least of the three alphabetical rows of a conventional Qwerty keyboard for mobile electronic devices. Indeed, the very thin rows (300), (301) and (302) represent respectively the upper, middle and lower rows of a conventional Qwerty keyboard.

According to the invention, the rows of said virtual keyboard Qwerty keyboard (for example the three alphabetical rows of keyboard (23) of FIG. 4)) extend along (and/or on, and/or parallel to) at least one side of the display (for example display (2)) of the device (for example device (1)). As shown in FIG. 4), and according to the invention, each of said very thin rows of alphabetical characters is preferably parallel, and/or preferably separated, from the other rows so that preferably (but not necessarily) the user's finger does not touch two thin virtual Qwerty keyboard rows at the same time.

According to the invention, at least one of said three very thin virtual rows of alphabetical keys and/or characters can act additionally as a visible locator of partly invisible and/or fully invisible alphabetical keys and/or row of alphabetical keys on the display.

According to the invention, the invisible surface (and/or zone) of said partly invisible and/or fully invisible row of keys and/or characters can extend along both sides (and/or along at least one side) of said at least one very thin, and/or non-invasive, visible locator row of alphabetical keys and/or characters extending in the shape of a thin and/or very thin elongated line.

Indeed, and as shown in FIG. 4, each one of said visible, and/or very thin, three rows of alphabetical keys and/or characters, preferably indicates the locations, on the display, of the partly invisible, and/or fully invisible, alphabetical keys and/or rows of keys that it visibly represents to the user in a non-invasive manner.

For example, the location of the invisible middle row (24), and/or the location of any of its various alphabetical keys and/or characters, is indicated by its visible part, and/or by its visible representation, being the very thin visible middle row of alphabetical keys and/or characters (301). For example, the location of the invisible upper row (26), and/or of the location of any of its various alphabetical keys and/or characters, is indicated by its visible part, and/or by its visible representation, being the very thin visible upper row of alphabetical keys and/or characters (300). For example, the location of the invisible lower row (27), and/or of the location of any of its various alphabetical keys and/or characters, is indicated by its visible part, and/or by its visible representation, being the very thin visible lower row of alphabetical keys and/or characters (302). In FIG. 4, the invisible rows (24), (26) and (27) preferably extend on both sides of their respective very thin row locators (301), (300) and (302).

According to the invention, said partly invisible and/or fully invisible alphabetical keys, and/or rows of alphabetical keys, can be located (and/or can extend) on both sides of said very thin visible rows, and/or at least on one side of said very thin visible rows.

As a consequence, and according to the invention, a key of a very thin visible virtual alphabetical row is preferably selected either: 1) if the user's finger touches at least a visible surface (and/or zone) on the display where said key is located on said alphabetical row, and/or 2) if the user's finger touches at least one of the two surrounding invisible surfaces (and/or zones) of (and/or represented by) said alphabetical key (zones located at least on the upper and/or on the bottom of said visible key).

According to the invention, this partly visible and/or invisible design of an alphabetical key, and/or row of alphabetical keys, allows said key, and/or row of keys, to be substantially larger than it appears. For example, middle row (301) is in reality substantially larger than it appears to the user, because of its surrounding invisible row (24). In the same manner, key (27) is in reality substantially larger than it appears to the user because of its surrounding invisible part (28). As a consequence, and according to the invention, the existence of said surrounding invisible part of a very thin alphabetical key, and/or row of alphabetical keys, is practical in order to avoid any instances of a user not touching, and/or missing, a very thin visible key when typing a word and/or a sentence. Indeed, and according to the invention, a very thin alphabetical key is selected, even if the user's finger misses it, as long as the invisible part of said alphabetical key is touched, and/or selected, by said user's finger.

According to the invention, at least one of the three (and/or four) very thin alphabetical (and/or command/function) rows of the virtual Qwerty keyboard is partly invisible, and can comprise visible alphabetical (and/or command/function) keys and/or characters which locate said partly invisible and/or fully invisible alphabetical (and/or command/function) keys that are located either: 1) above their respective visible key locator, and/or 2) on their respective visible key locator, and/or 3) below their respective visible key locator.

According to the invention, the organization, and/or arrangement, of said partly invisible and/or fully invisible virtual alphabetical keys (above, and/or on, and/or below the visible part of at least one very thin alphabetical row) allows said keys to be selected without the possibility of typing errors.

Indeed, and according to the invention, the visible and/or invisible surface (and/or zone) of selection of a particular alphabetical (and/or command/function) key can be clearly separated from (and/or located at another level than) the visible and/or invisible surfaces (and/or zones) of selection of the alphabetical (and/or command/function) keys surrounding it (and/or next to it) on said row. Indeed, and according to invention, an alphabetical key having a particular visible and/or invisible surface (and/or zone) of selection can be surrounded by (and/or next to) alphabetical (and/or command/function) keys having different visible and/or invisible surfaces (and/or zones) of selection which are located at a different level on said row.

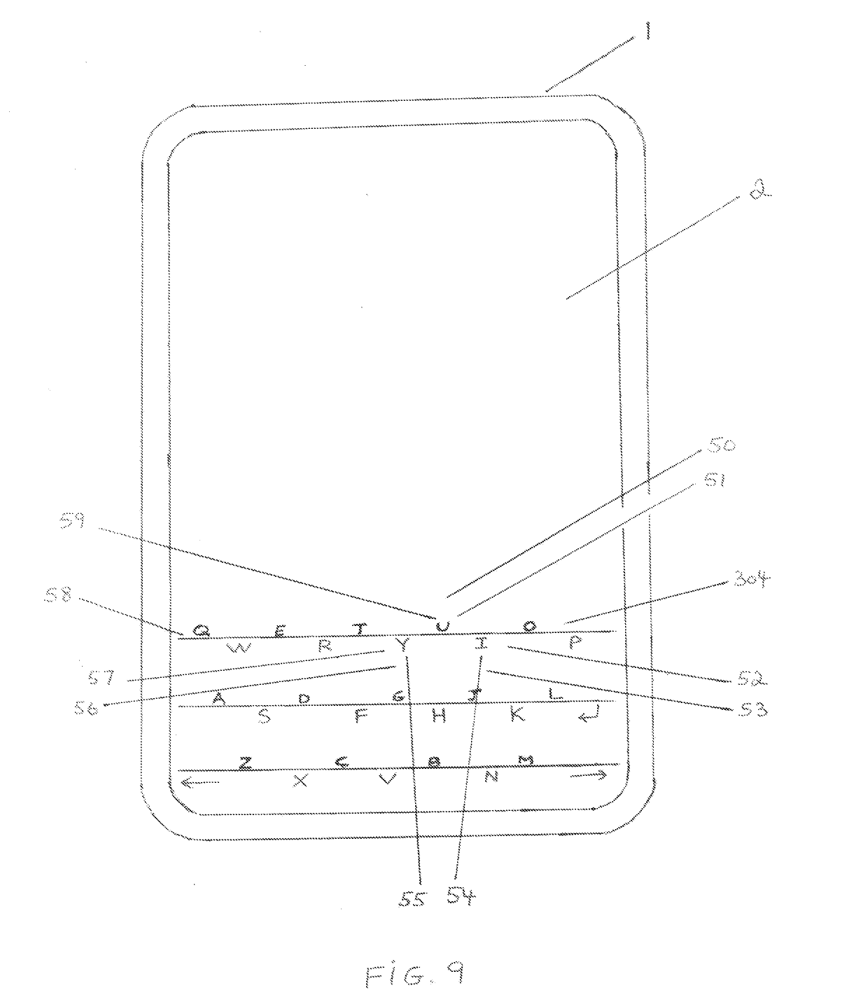

For example, and as shown in FIG. 9, if an alphabetical key (such as (59)) has an invisible surface (and/or zone) of selection (such as (50)) located at a level above its very thin visible row of alphabetical keys and/or characters (such as upper row (304)), then said key (such as (59)) is preferably surrounded by (and/or next to) keys (such as (55) and (54)) having invisible surfaces (and/or zones) of selection (such as (56) and (53)) located at a level below said very thin visible row of alphabetical keys and/or characters (such as upper row (5)).

According to the invention, and as shown in FIG. 9, alphabetical (and/or command/function) keys (such as (55) and (54)) having visible and/or invisible surfaces (and/or zones) of selection located at a level below said very thin visible row of alphabetical (and/or command/function) keys (such as upper row (304)) can have (for example) their visible key locators (such as (57) and (52)) appear at a lower level (and/or appear in a different color) than the alphabetical (and/or command/function) keys (such as (59)) having visible and/or invisible surfaces (and/or zones) of selection (respectively such as (51) and (50)) located at a level above said very thin visible row of alphabetical (and/or command/function) keys (such as upper row (304)).

According to the invention, and as shown in FIG. 9, a visual border (and/or separation) line (such as (58)) can additionally appear between the above and lower levels of alphabetical (and/or command) keys of a row in order to clearly and/or visually show to the user where start the visible and/or invisible surfaces of selection of said above and lower levels of alphabetical (and/or command/function) keys.

According to the invention, the difference in color, and/or the difference in level position, and/or the separation line, between the above and lower levels of alphabetical (and/or command) keys of a row, is done in order to clearly visually distinguish, and/or separate, said two levels of alphabetical (and/or command) keys on said row. Indeed, said visual distinction and/or separation, makes the user intuitively understand (and/or see) that in order to select a key of the above level, and/or of the lower level, said user has to at least touch a surface (and/or zone) located respectively above, and/or below, said visible row of alphabetical (and/or command/function) keys.

According to the invention, at least one of the non-invasive rows of alphabetical keys and/or characters of the virtual keyboard unit is a thin and/or very thin elongated visible portion, in the shape of a line, of a partly invisible and/or fully invisible row of alphabetical keys located anywhere on the display.

Indeed, as shown in FIG. 4, the middle row (301) is the very thin elongated visible portion, in the shape of a line on the display, of the partly invisible row of alphabetical keys (20). Said partly invisible alphabetical row (20) comprises a visible (and very thin) portion (301) and an invisible portion (24). According to the invention, a partly invisible alphabetical row at least comprises: 1) a visible, and/or very thin, and/or non-invasive, and/or portion of alphabetical keys and/or characters, and 2) an invisible linear portion of alphabetical keys and/or characters extending along at least one side of said visible, and/or very thin, and/or linear portion.

According to the invention, a virtual alphabetical Qwerty keyboard unit comprising a shift key, and/or responding to any type of input signal to shift from:

1) a virtual alphabetical Qwerty keyboard unit on which at least all three rows of alphabetical keys and/or characters are shown in their conventional and/or usual form on the display, to

2) a virtual alphabetical Qwerty keyboard unit on which less than three (but at least one) of said rows of alphabetical keys and/or characters are shown in their conventional and/or usual form on the display.

According to the invention, a user can shift from a conventional virtual alphabetical Qwerty keyboard unit comprising at least three usual rows of alphabetical keys and/or characters, to a virtual alphabetical Qwerty keyboard unit comprising less than three usual rows of alphabetical keys and/or characters, preferably through the input signal of an outward slide movement on the display of the user's finger sliding out of said display (through a visual effect) the image of at least one of said usual rows of alphabetical keys and/or characters.

Conversely, and according to the invention, the user can shift from a virtual alphabetical Qwerty keyboard unit comprising less than three usual rows of alphabetical keys and/or characters, to a conventional virtual alphabetical Qwerty keyboard unit comprising at least the three usual rows of alphabetical keys and/or characters, preferably through the input signal of an inward slide movement on the display of the user's finger sliding in said display (through a visual effect) the image of at least one of said usual rows of alphabetical keys and/or characters. According to the invention, an outward slide movement of the user's finger is directed toward the edges of the display, and an inward slide movement of the user's finger is directed toward the center of the display.

According to the invention, a virtual alphabetical Qwerty keyboard unit at least comprising:

1) One fully visible row (and/or partly invisible, and/or fully invisible very thin row locator) of alphabetical characters comprising at least a substantial part of the usual alphabetical keys and/or characters of a usual upper Qwerty row, working at least, and/or in priority, with an unambiguous input of alphabetical characters, and

2) at least one fully visible ambiguous key, and/or at least one partly invisible and/or fully invisible ambiguous key locator, to which are assigned the alphabetical characters of at least one of the two usual alphabetical bottom rows of a Qwerty keyboard unit.

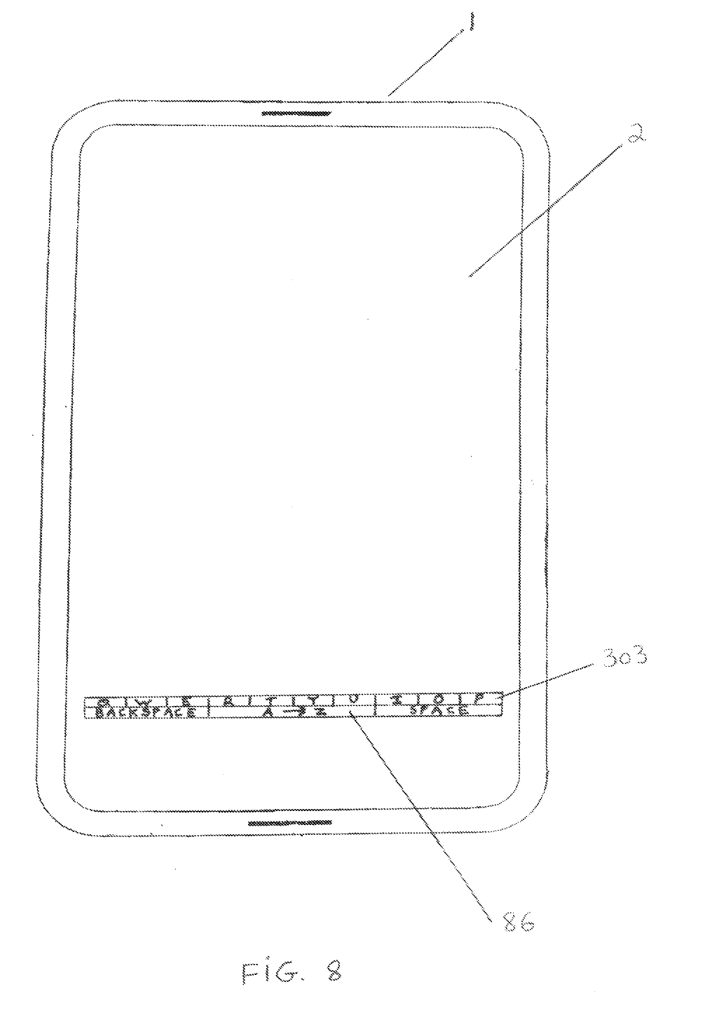

A usual upper row of a virtual Qwerty keyboard comprises most of the vowels of the alphabet. Consequently, and according to the invention, the keys of said upper row (such as upper row (303) of FIG. 8) are at least, and/or in priority, selected unambiguously (and/or precisely, and/or character by character) in order to improve the accuracy of the text entry system of said virtual keyboard unit. In the instance of FIG. 8, the alphabetical keys and/or characters of the two lower rows are represented, and/or are assigned, to a partly invisible very thin and/or linear (and/or preferably spacious) ambiguous key locator (86), located and/or extending below the conventional/usual upper row (303) which works at least, and/or in priority, with an unambiguous input of alphabetical characters.

The alphabetical characters of the two lower Qwerty rows are at least, and/or in priority, selected through the use of an ambiguous text input technology, where an alphabetical key selection can be open to several interpretations as to what alphabetical character is being entered by the user (for example, a predictive text entry technology).

According to the invention, a function and/or a command, which can be selected through any type and/or form of input signal, in order to make transparent, and/or invisible, and/or see-through, the visible surrounding surfaces (and/or zones), and/or visible border lines, of virtual keys, and/or rows of keys, of a conventional virtual alphabetical Qwerty keyboard unit.

According to the invention, said function and/or command can make:

1) only the images of alphabetical characters and/or commands (and/or the images of rows of alphabetical characters and/or commands) visible to the user on the display, and/or

2) only very thin lines (and/or very thin rows) of alphabetical characters and/or commands, preferably surrounded by very narrow border lines having an height approximately equal to the height of the small size alphabetical characters and/or commands they surround, visible to the user on the display.

This transparency function, and/or command, can allow a gradual level of transparency and/or invisibility, and/or an immediate full transparency and/or invisibility, of said surroundings and/or border lines. Also, and according to the invention, said transparency function, and/or another separate function and/or command on the keyboard, can additionally make the images of the alphabetical characters and/or commands of said virtual keyboard unit appear in smaller sizes and/or dimensions.

According to the invention, a zone (and/or surface) on the display comprising at least two visible virtual alphabetical characters appearing on said surface, and wherein at least one of said visible virtual alphabetical character can be selected by a user's finger touching said surface (and/or zone) where said alphabetical characters appear, and/or wherein at least another one of said at least two alphabetical characters can be selected by a user's finger touching a surface (and/or zone) on the display outside of said surface (and/or zone) where said at least two alphabetical characters appear.

All the inventive ideas and principles described in this patent application should, and/or can, be applicable to any virtual keyboard locator units, and/or to any virtual keyboard units, comprising:

1) rows of alphabetical keys and/or alphabetical characters arranged in any possible alphabetical arrangement, and not only in a Qwerty arrangement. Indeed, even if a Qwerty arrangement is specifically mentioned in, and/or is specifically applied to, an inventive idea described in this patent application, this idea should also be applicable to any virtual keyboard locator unit, and/or on any virtual keyboard unit, which can have any other alphabetical arrangement, preferably as long as it is feasible, and/or obvious, for a person skilled in the art, to apply any of the inventive ideas and principles described above to a virtual keyboard unit having a different arrangement of its alphabetical characters.

2) any number of rows, and/or lines, of alphabetical keys and/or characters (and/or command, and/or function, and/or symbol keys). Indeed, the inventive ideas described in this patent application are not only applicable to virtual units comprising only three rows of alphabetical keys and/or characters. In fact, the basic ideas and/or principles disclosed in this patent application should be applicable to any virtual keyboard unit which comprises at least one row, and/or line, of alphabetical keys and/or characters (and/or commands, and/or function, and/or symbol keys).

3) alphabetical keys comprising any number of alphabetical characters. Indeed, the inventive ideas described in this application can be applied to either: a) alphabetical keys which comprise only one alphabetical character per key (unambiguous alphabetical keys), and/or b) alphabetical keys which comprise several alphabetical characters per key (ambiguous alphabetical keys). According to the invention, a virtual alphabetical key can be defined by a zone on the touch screen surface of the display.

4) at least one row of alphabetical keys which can comprise any number of alphabetical keys.

5) rows of alphabetical keys and/or alphabetical characters (and/or symbols) from any foreign language (for example: Chinese and/or Indian alphabetical characters and/or symbols).

According to the invention, any unambiguous text entry/input system of any of the virtual keyboard locator units (and/or virtual alphabetical keyboard units) described in this patent application can preferably work in combination with (and/or with the support of) any type of ambiguous text entry/input system (such as for example any type of word predictive text entry/input system, and/or a text entry/input system which at least analyzes the overall shape derived from the locations on the display touched by the user's finger in order to predict which word said user intends to enter) at least in order to auto-correct instances where the user mistypes a word.

According to the invention, any alphabetical key of any of the virtual keyboard locator units (and/or of any of the thin virtual keyboard units) described in this patent application, can be selected not only through a touch of the user's finger, but also through any other type (and/or manner, and/or form) of input command and/or signal.

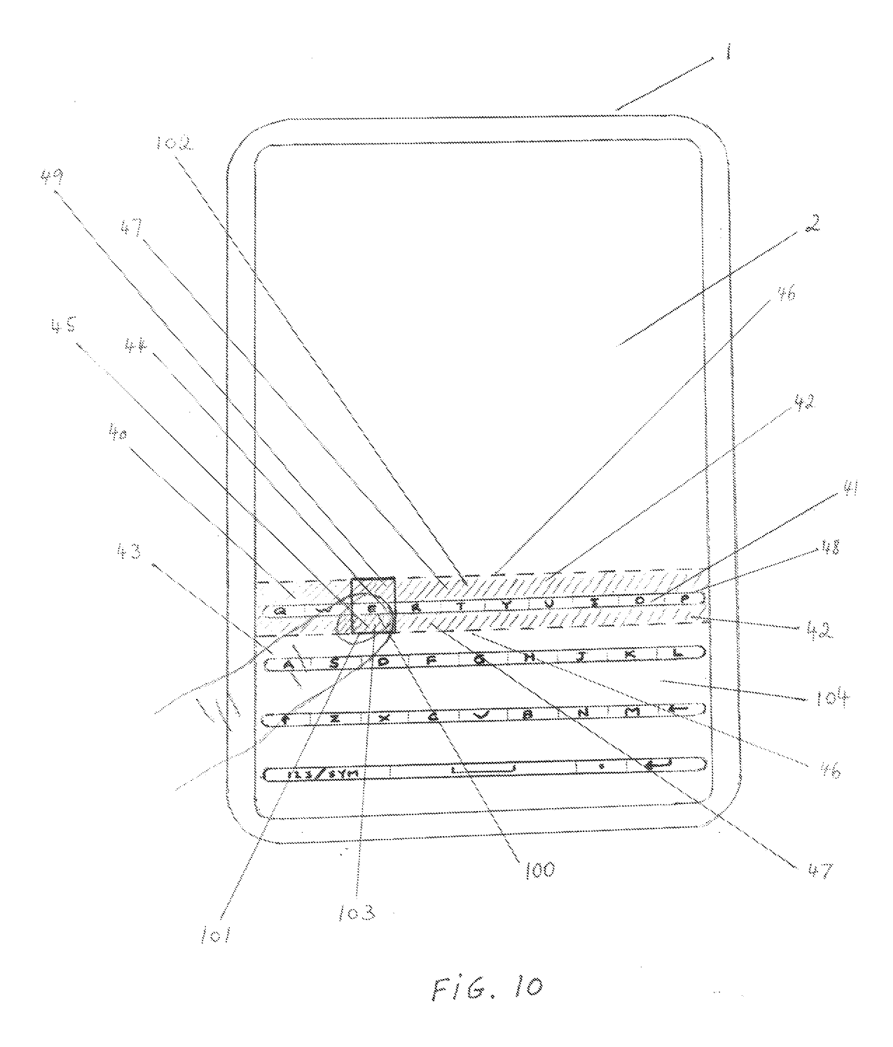

According to the invention, and as shown in FIG. 10, a virtual Qwerty keyboard (and/or keyboard locator) unit (such as unit (104)) comprising: at least one partly invisible row of alphabetical (and/or command) keys (such as upper row (40)), whose visible area (such as area (41)) has an overall thin and/or elongated horizontal shape, and whose invisible area (such as area (42)) becomes visible if a user selects (for example: through a finger touch, such as finger (43)) a visible and/or an invisible area of at least one key (such as key (49)) of said row.

According to the invention, and as shown in FIG. 10, a virtual Qwerty keyboard (and/or keyboard locator) unit (such as unit (104)) comprising: at least one partly invisible row of alphabetical (and/or command) keys (such as upper row (40)), whose visible area (such as area (41)) has an overall thin and/or elongated horizontal shape, and wherein the invisible area (such as area (45)) of a partly invisible key (such as key (49)) of said row becomes visible if a user selects (for example: through a finger touch, such as finger (43)) a visible area (such as area (44)) and/or an invisible area (such as area (45)) of said key.

According to the invention, and as shown in FIG. 10, the invisible area of a row (such as area (42)), and/or the invisible area of a key (such as area (45)), becomes visible to a user at least through the appearance of:

1) Additional border lines surrounding said invisible areas (such as additional border lines (46) of the partly invisible upper row (40), and/or such as additional border lines (101) of partly invisible key (49)), and/or

2) A see-through background, having a specific level of transparency, and visually defining the shape of said invisible areas (such as the see-through background (102) of the partly invisible upper row (40), and/or such the see-through background (103) of the partly invisible key (49)).

According to the invention, the invisible area of a row (and/or the invisible area of at least one of its keys) can become visible at least in order to:

1) Show to the user the invisible limits of said row (and/or the invisible limits of at least one of its keys), and/or

2) Show to the user that said visible very thin row (and/or at least one of its keys) can also be selected comfortably by touching also its surrounding invisible area of selection.

According to the invention, and as shown in FIG. 10, a conventional virtual Qwerty keyboard (and/or keyboard locator) unit (such as unit (104)) comprising partly invisible alphabetical (and/or command) rows whose visible and very thin linear shapes result at least from their thin and/or elongated visible areas, and wherein:

1) Said thin and/or elongated visible areas are surrounded by visible narrow border lines (such as visible border lines (48) of the thin and/or elongated visible area (41) of the partly invisible upper row (40)), and

2) Said partly invisible rows (and/or their keys) comprise additional invisible areas of selection which are located outside (and/or are surrounding) their respective visible thin and/or elongated areas of selection and/or their narrow border lines (such as the invisible area (42) located outside the visible border line (48) of the thin and/or elongated visible area (41) of the partly invisible upper row (40)).

According to the invention, and as shown in FIG. 10, a conventional virtual Qwerty keyboard (and/or keyboard locator) unit (such as unit (104)) comprising at least one partly invisible row of alphabetical (and/or command) keys (such as upper row (40)), whose visible area (such as (41)) has an overall thin and/or elongated horizontal shape resulting at least partly from its surrounding visible and narrow border lines (such as (48)), and wherein:

1) At least one partly invisible key of said row (such as key (49)) has a visible area (such as area (44)) having an overall thin and/or elongated shape resulting at least partly from its surrounding visible and narrow border lines (such as (100)), and

2) Said partly invisible key can be selected at least if a user selects (for example: through a finger touch, such as (43)) an invisible area of selection, assigned to said partly invisible key, which is located outside, and/or which is surrounding, said visible narrow border lines of said partly invisible key (such as the invisible area (45), located outside the narrow border lines (100), of said visible area (44), of the partly invisible key (49)).

According to the invention, and as shown in FIG. 4, a compact virtual Qwerty keyboard locator unit (such as unit (23)) comprising only three rows of keys (such as (300), (301) and (302)), wherein:

1) The alphabetical keys are arranged in a conventional Qwerty manner on said three rows, and

2) The basic “SPACE” command key (as shown in (30)) is located either: a) on the middle or lower alphabetical rows, and/or b) separately anywhere on the display.

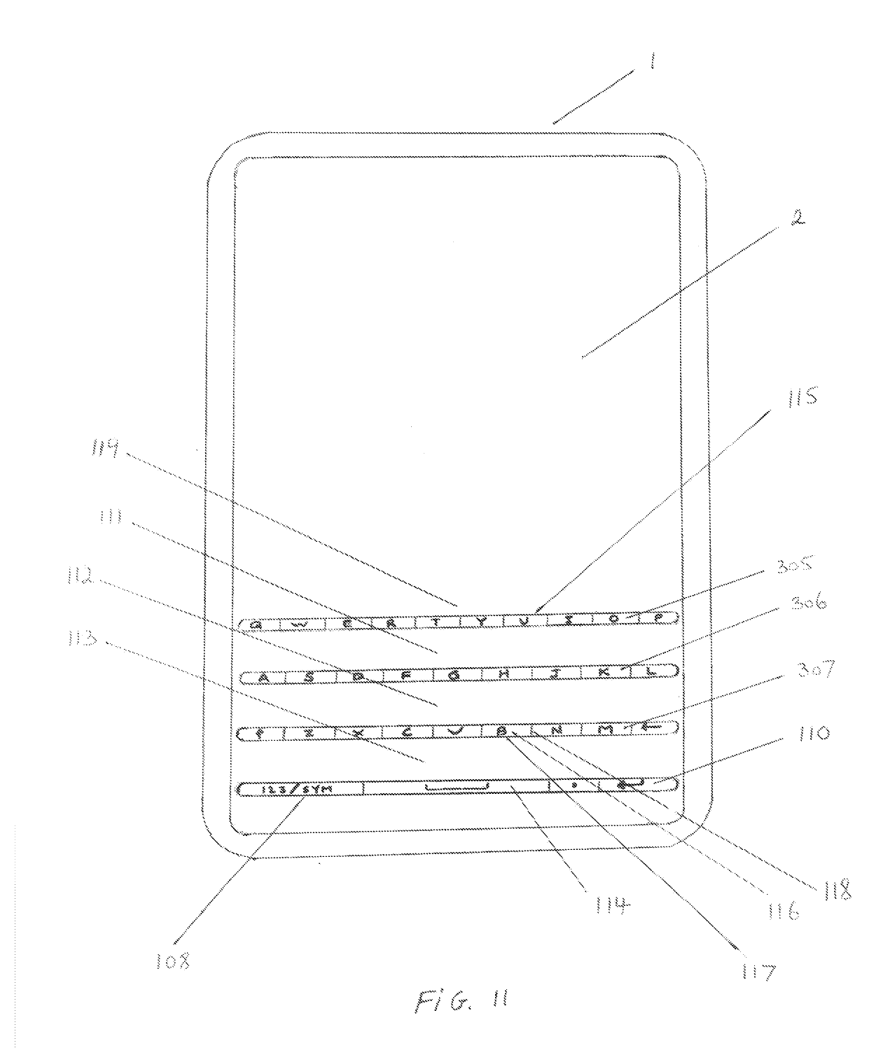

According to the invention, and as shown in FIG. 11, a virtual Qwerty keyboard unit (such as unit (108)) expanding on a wide area (such as wide area (119)) on the display of a mobile telecommunication device (such as device (1)), and wherein said area is occupied:

1) In minority, by smaller zones (such as zones (305), (306), (307) and (110)) having overall thin and/or elongated horizontal shapes, and on which the alphabetical (and/or command) keys of said virtual keyboard unit appear on and/or are assigned to, and

2) In majority, by substantially larger and/or wider keyless zones (such as (111), (112) and (113)), expanding also horizontally, and located between (and/or next to, and/or separating) said small zones.

According to the invention, and as shown in FIG. 11, a virtual Qwerty keyboard unit (such as unit (108)) expanding on a wide area (such as wide area (119)) on the display of a mobile telecommunication device (such as device (1)), and wherein said area is occupied:

1) By zones (such as zones (305), (306), (307) and (110)) having overall thin and/or elongated horizontal shapes, and on which the alphabetical (and/or command) keys of said virtual keyboard unit appear on and/or are assigned to, and

2) By keyless zones (such as (111), (112) and (113)), expanding also horizontally, and located between (and/or next to, and/or separating) said zones carrying keys, and wherein the dimensions of said keyless zones are substantially larger than the dimensions of said thin and elongated key zones.

According to the invention, and as shown in FIG. 11, the majority of said wide area (such as wide area (119)) of the virtual keyboard unit (such as unit (108)) is occupied by said larger free and/or vacant keyless zones (such as zones (111), (112) and (113)), as a consequence, said virtual keyboard unit offers to the user an almost unobstructed view of background images of other software applications that could appear under said virtual keyboard unit.

According to the invention, and as shown in FIG. 11, said smaller zones (such as zones (305), (306), (307) and (110)) can have overall thin and/or elongated rectangular shapes expanding horizontally on the display.

According to the invention, and as shown in FIG. 11, said substantially larger keyless zones (such as zones (111), (112) and (113)) can have the shape of larger rectangles expanding horizontally on the display.

According to the invention, and as shown in FIG. 11, said wide area (such as wide area (119)) of the virtual keyboard unit on the display can have the shape of a rectangle and/or a square.

According to the invention, and as shown in FIG. 11, said virtual Qwerty keyboard unit (such as unit (108)) is expanding on a wide area (such as wide area (119)) occupying approximately (and/or on average) between twenty percent to fifty percent of the surface of the display area (as it is the case for most conventional virtual Qwerty keyboards of mobile telecommunication devices), and wherein the majority of said wide area of said virtual keyboard unit is occupied by said larger free and/or vacant keyless zones (such as zones (111), (112) and (113)), and wherein as a consequence, said virtual keyboard unit offers to the user an almost unobstructed view of background images of other software applications that could appear under said virtual keyboard unit.

According to the invention, and as shown in FIG. 11, said virtual Qwerty keyboard unit (such as unit (108)) is expanding on a wide area (such as wide area (119)) occupying approximately (and/or on average) between twenty percent to fifty percent of the surface of the display area (as it is the case for most conventional virtual Qwerty keyboards of mobile telecommunication devices), and wherein the area of a keyless zone (such as the area of the keyless zone (112)) is at least two times larger in dimensions than the area of a thin and/or elongated zone carrying keys (such as the area of the thin and elongated zone (305)).

According to the invention, and as shown in FIG. 11, the virtual Qwerty keyboard unit (such as unit (108)) described in the present invention comprises at least the three alphabetical rows of a conventional virtual Qwerty keyboard (such as alphabetical rows (305), (306) and (307)), and wherein at least some of the basic command keys of said unit (such as the “Space” command key (114)) are located either: a) on a separate and conventional fourth row (as it is the case with the bottom command row (110)), and/or b) on the second and/or third alphabetical rows, and/or c) anywhere on the display.

According to the invention, and as shown in FIG. 11, the small zones carrying keys (such as zones (305), (306) and (307)) can be at least partly transparent and/or see-through.

According to the invention, and as shown in FIG. 11, a small zone carrying keys (such as zone (305)) can be visually detected (and/or limited) at least: a) by conventional visible border lines surrounding it (such as visible border lines (115)), and/or b) by a see-through background having a specific level of transparency and having said thin and/or elongated shape.

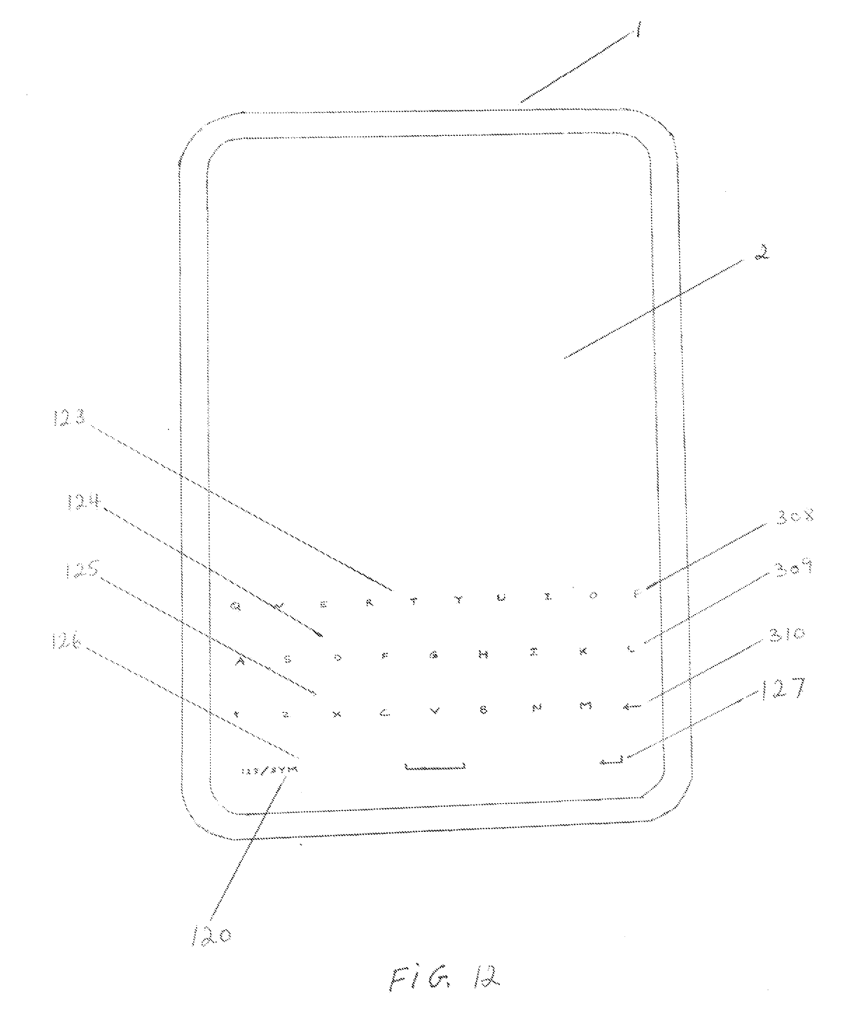

According to the invention, and as shown in FIG. 12, a virtual Qwerty keyboard unit (such as unit (120)) expanding on a wide area (such as wide area (123)) on the display of a mobile telecommunication device (such as device (1)), and wherein said area is occupied:

1) In minority, by smaller zones (such as zones (308), (309), (310) and (127)) having overall thin and/or elongated horizontal shapes on which the alphabetical (and/or command) keys of said virtual keyboard unit appear on and/or are assigned to, and wherein said alphabetical and/or command keys: a) are not surrounded by any conventional and/or visible border lines when appearing on said small zones, and/or b) preferably (but not necessarily) appear over a see-through background (having a specific level of transparency) defining said thin and/or elongated shape of said zones, and

2) In majority, by substantially larger and/or wider keyless zones (such as zones (124), (125) and (126)), expanding also horizontally, and located between (and/or next to, and/or separating) said small zones, and wherein said larger and/or keyless zones are not surrounded by any conventional and/or visible border lines.

According to the invention, and as shown in FIG. 11, a virtual thin key (such as key (116)) of a virtual thin row (such as row (307)) of said virtual keyboard unit (such as unit (108)) is a key whose horizontal length (such as length (117)) is substantially greater in dimensions than its vertical height (such as height (118)), at least in the instance where (and/or even if) the mobile telecommunication device (such as device (1)) is held vertically, and said virtual keyboard unit appears (and/or expands) in a narrow and/or vertical mode (as opposed to a wide/landscape and/or horizontal mode) on the display.

According to the invention, and as shown in FIG. 11, said virtual thin key (such as key (116)) of a virtual thin row (such as row (307)) of a virtual keyboard unit (such as unit (108)) can be a key whose horizontal length (such as length (117)) can be at least two times greater in dimensions than its vertical height (such as height (118), at least in the instance where (and/or even if) the mobile telecommunication device (such as device (1)) is held vertically and said virtual keyboard unit appears (and/or expands) in a narrow and/or vertical mode (as opposed to a wide/landscape and/or horizontal mode) on the display.

According to the invention, and as shown in FIG. 4, a virtual Qwerty keyboard unit (such as unit (23)) expanding:

1) on a wide area (such as area (32)) on the display of a mobile telecommunication device, and

2) over background images of at least one other software application appearing also on said display, and wherein said keyboard area is occupied:

a) In minority, by small zones (such as zones (300), (301) and (302)) having overall thin and/or elongated horizontal shapes and on which the alphabetical (and/or command) keys of said virtual keyboard unit appear on and/or are assigned to, and wherein said small zones are at least slightly obstructing the view of the background images of said at least one other software application, and

b) In majority, by substantially larger zones (such as zones (21) and (22)), expanding also horizontally, and located between (and/or separating) said small zones, and wherein said larger zones are comprised of either: a) invisible keys and/or see-through keys having a specific level of transparency, and/or b) empty and/or keyless zones, and wherein said larger zones are not obstructing the view of the background images of said at least one other software application.

According to the invention, and as shown and described previously in FIG. 2, a virtual Qwerty keyboard (and/or keyboard locator) unit (such as unit (3)) can take the shape of a thin rectangular row, and/or of a thin long strip, and/or of a thin rectangular software window.

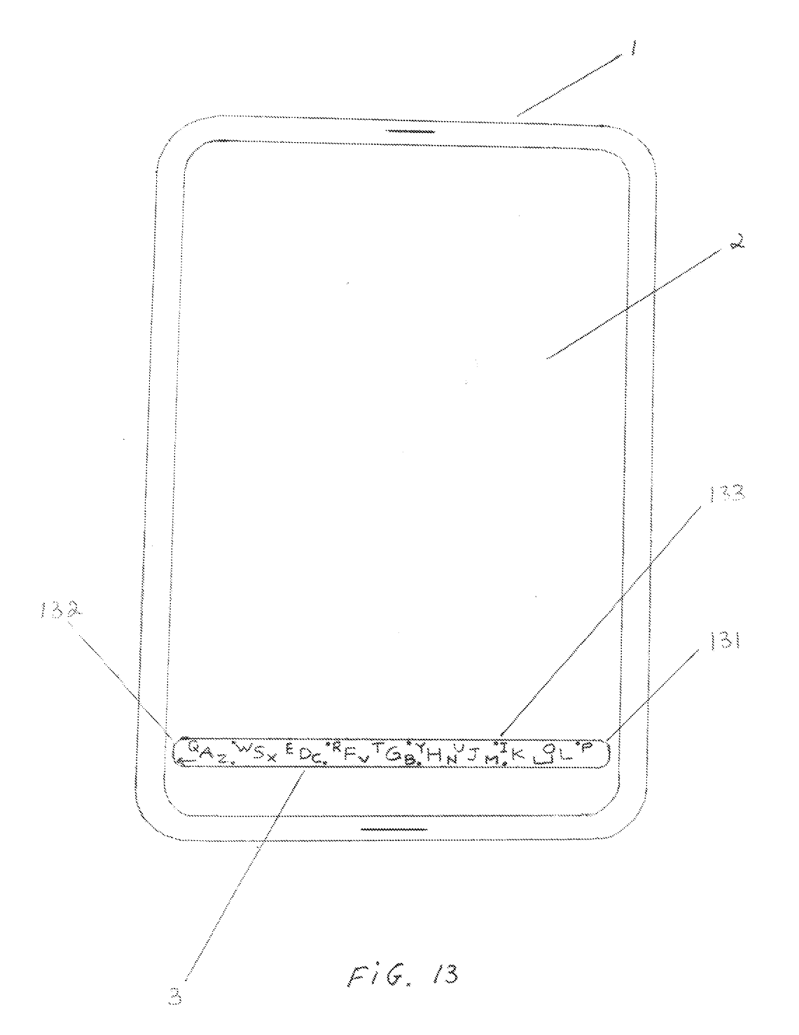

According to the invention, and as shown in FIG. 13, the end, and/or extremity, and/or corners, of said thin rectangular row (such as end and/or extremity (131) and (132)) can have a curved shape design.

According to the invention, and as shown in FIG. 13, additional key locator (and/or indicator) instruments (such as for example dot (133) appearing next to the key locator for the “I” alphabetical character) can appear next to some key locators, in order to indicate to the user the partly invisible (and/or fully visible) locations on the display of the keys indicated by said key locators. In particular, and according to the invention, said additional key locator (and/or indicator) instruments can indicate the invisible location of keys which are located either further away from, and/or closer to, their respective key locators.

For example, and as shown in FIG. 13, an additional key locator (and/or indicator) instrument such as dot (133) preferably indicates that the invisible “I” key is located deeper in the display than its two surrounding invisible keys “U” and “O” which do not have additional dot indicators assigned to their respective key locators and which invisible locations on the display are as a consequence located closer to the keyboard locator unit (3).

According to the invention, a mobile telecommunication device comprising an apparatus for detecting the location of a user's finger over the display of said device without said finger touching said display, and wherein a virtual Qwerty keyboard (and/or keyboard locator) unit is located on said display, and wherein at least some of the keys of said unit are either at least partly invisible and/or fully invisible, and wherein at least one said key becomes visible, and/or appear in substantially larger dimensions, when said finger is located over an area assigned to said at least one key.

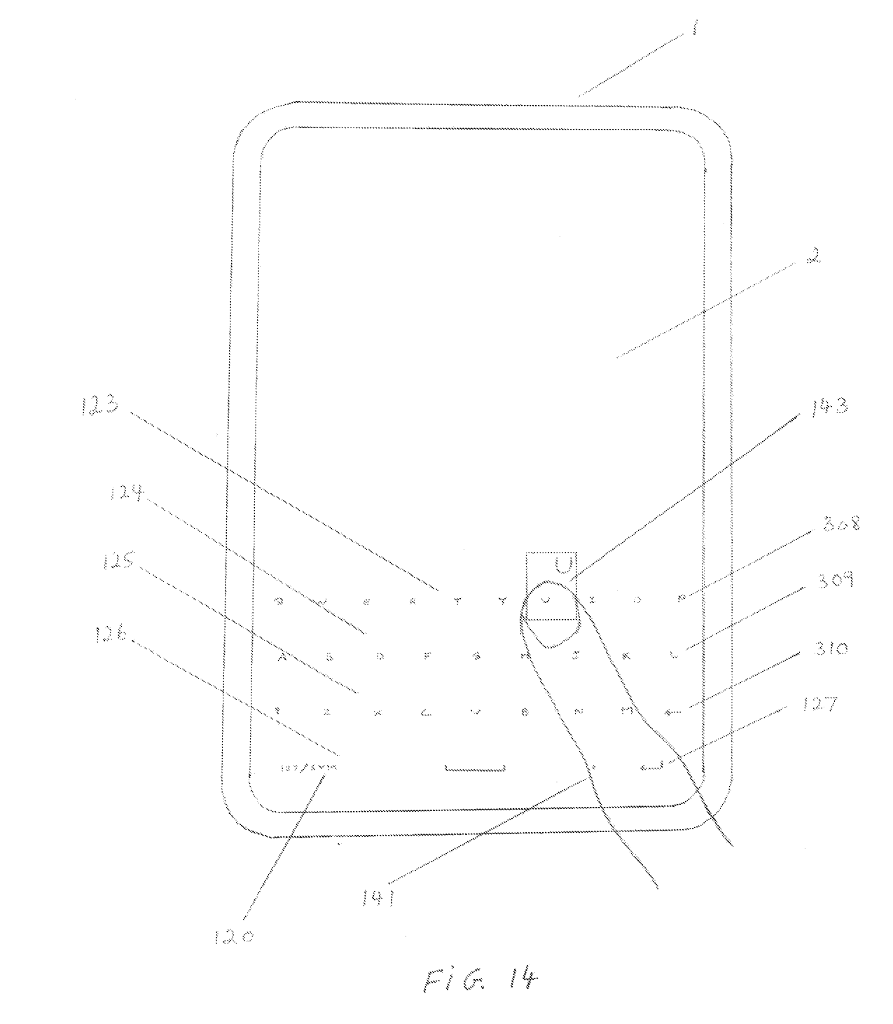

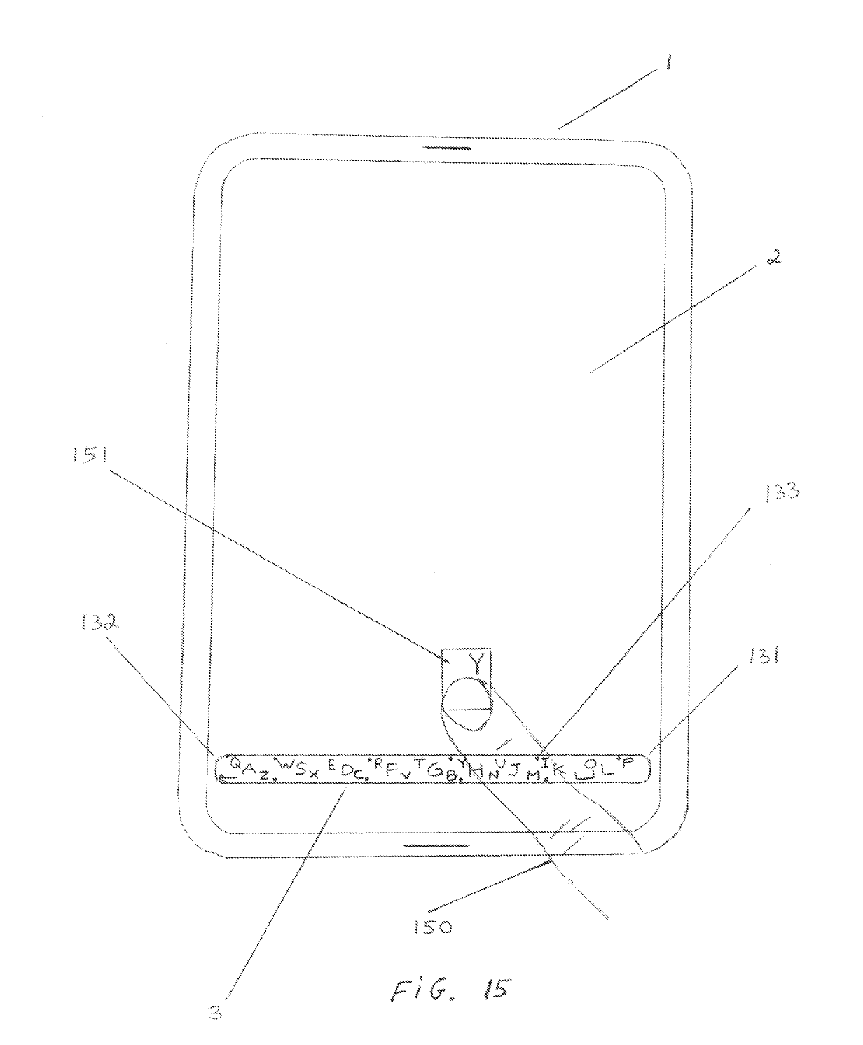

Indeed, and as shown in FIG. 14 and FIG. 15, a mobile telecommunication device (such as (1)) comprising an apparatus for detecting the location of a user's finger over the display (such as (2)) of said device without said finger (such as (141)) touching said display (such as (2)), and wherein a virtual Qwerty keyboard (and/or keyboard locator) unit (such as (120)) is located on said display (such as (2)), and wherein at least some of the keys of said unit are either at least partly invisible and/or fully invisible, and wherein as an example, virtual key (143) and (151) become visible, and/or appear in substantially larger dimensions, when finger (141) is located over an area assigned to them.

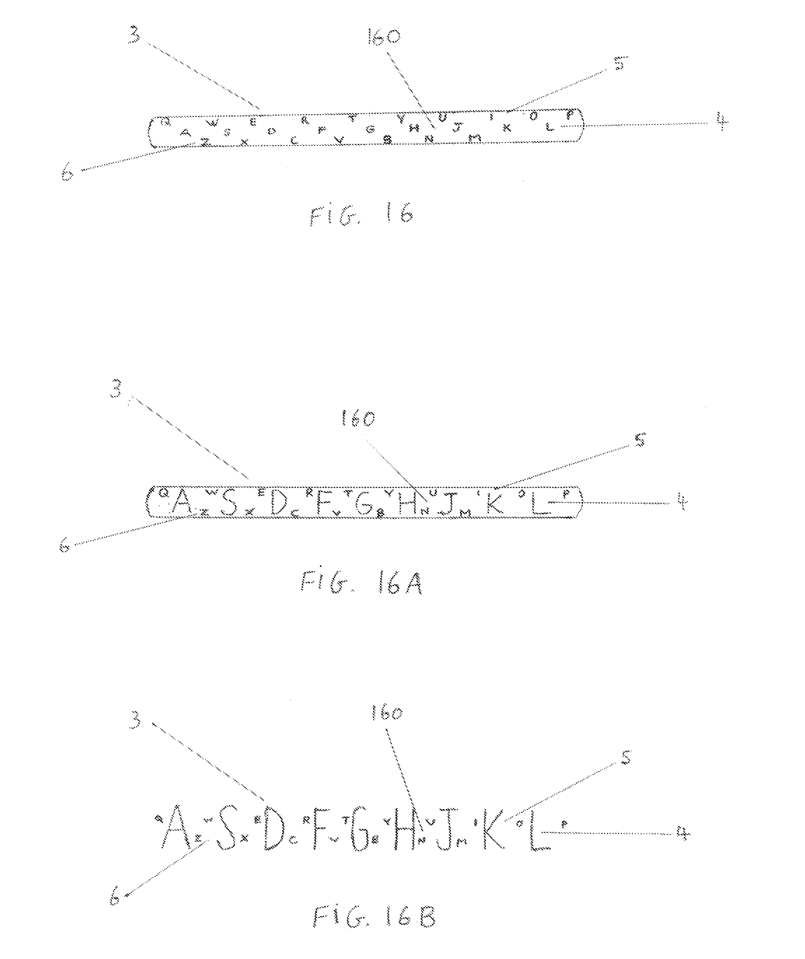

FIG. 16 shows another embodiment (and/or alphabetical characters/keys configuration/arrangement) of the very thin linear virtual keyboard locator unit (such as (3)). Said virtual keyboard locator unit (such as (3)) works, at least substantially and/or preferably, in the same manner (and/or with the same basic principles) than the virtual keyboard locator unit (such as (3)) described in the embodiments of FIG. 1 and FIG. 2. Said keyboard locator unit (such as (3)) of FIG. 16 is also very close in its appearance (and/or its configuration) to the keyboard locator unit (such as (3)) of FIG. 1.

Indeed, and as it is the instance in FIG. 1, FIG. 16 shows a virtual alphanumerical keyboard locator unit (such as (3)) appearing as an image on the display of a mobile telecommunication device. Said keyboard locator unit (such as (3)) has an overall thin and/or linear shape, and/or the shape of a thin band. Said virtual keyboard locator unit (such as (3)) at least comprises the three conventional rows (and/or levels) of alphabetical characters of a conventional alphabetical Qwerty keyboard, such as the middle alphabetical row/level (such as (4)) and the two other alphabetical, and/or external, rows/levels which are the upper row/level (such as (5)), and the lower row/level (such as (6)). Said three visible rows/levels of alphabetical characters and/or keys are, at least substantially and/or preferably, comprised into said virtual keyboard locator unit (such as (3)) having, preferably but not necessarily, the shape of a thin linear software window. Indeed, and according to the invention, said thin linear virtual keyboard locator does not have to be necessarily surrounded by the visible border lines of a software window. As shown in the embodiment of FIG. 16, and according to the invention, at least part of the images of the alphabetical characters and/or keys of said upper, middle and lower rows/levels, are at least substantially extending next to (and/or side by side, and/or parallel, and/or contiguous to) each other, as it is also the instance in FIG. 1.

The virtual keyboard locator unit (such as (3)) of FIG. 16A shows a variation from the keyboard locator unit (such as (3)) of FIG. 16. In FIG. 16A, the dimensions (and/or size) of at least a substantial number of the alphabetical characters of the middle row (such as (4)) are increased to the point that the images of said middle row characters insert themselves to the level, and/or in, and/or between, the images of the characters of the upper row (such as (5)) and/or lower row (such as (6)). As shown in FIG. 16 and FIG. 16A, the original distance (such as (160)) between the upper row (such as (5)) and the lower row (such as (6)) preferably (but not necessarily) remains the same and/or stable. In fact, said upper row (such as (5)) and/or lower row (such as (6)) are not compressed toward one another and/or toward said middle row (such as (4)). In fact, it is the middle row characters (such as (4)) of the keyboard locator unit (such as (3)) which are enlarged, and/or which expand as a consequence to the levels of the upper row (such as (5)) and lower row (such as (6)).

According to the invention, the advantages of the enlargement, and/or expansion, of the dimensions of the images of the alphabetical characters of the middle row/level are:

1) To allow the user to visually distinguish in a clear, and/or quick, and/or intuitive manner, said middle row/level of alphabetical characters from the characters of the two other external upper and/or lower rows/levels. This difference in the dimensions of the characters of the middle row/level creates a visual, and/or intuitive, separation effect between the characters of said middle row/level and the characters of the two other external upper and/or lower rows/levels, and this even if these three rows/levels of characters extend together on a thin linear and/or narrow surface located preferably along one side of the display (such as (2)) of the mobile telecommunication device (such as (1)). Please note that the color of the characters of the middle row/level can also be different from the color of the characters of the other two external rows/levels in order to increase said intuitive visual separation effect; and

2) To create a compact, and/or very thin, virtual keyboard locator unit resulting in part from said at least three rows/levels of alphabetical characters being inserted into one another.

Therefore, and according to an embodiment of the invention, at least some of the visible alphabetical characters of said middle row are operatively increased to a predetermined dimension such that the characters of said middle row can be operatively inserted between the characters of said upper row and/or said lower row, in order to provide: a) a compact shape of said locator; and b) an intuitive visual separation effect between said three rows of visible alphabetical characters arranged together into an elongated shape.

Going further, and as shown in the embodiment of FIG. 16B, the dimensions of the images of the alphabetical characters of the middle row/level (such as (4)) can be increased to the point that said images extend (and/or expand) even higher (and/or further) than the level of the characters of the upper row/level (such as (5)), and/or even lower (and/or further) than the characters of the lower row/level (such as (6)).

In fact, FIG. 16B shows a very thin virtual keyboard locator unit (such as (3)) which can be miniaturized, and comprise alphabetical characters of its upper row and lower rows/levels which are included inside the level of the characters of the middle row. The characters of the middle row/level are intuitively distinguishable from the characters of the upper and lower rows/levels at least because of their different dimensions and/or color. In the embodiment of FIG. 16B, the characters of the upper and lower rows/levels are included into the level of the middle row, and this even if the initial distance between said upper and lower rows (such as (160)) is, at least proportionally, the same (and/or not decreased).

As shown in the embodiment of FIG. 16B, the characters of the upper and/or lower rows/levels have small dimensions (and/or have their dimensions, such as height and/or width, decreased) compare to the dimensions of the characters of the middle row/levels. As a consequence, and according to the invention, said small upper and lower rows/levels characters act, and/or are, discrete indicators (and/or locators) of the at least partly invisible keys of said upper and lower rows/levels of characters.

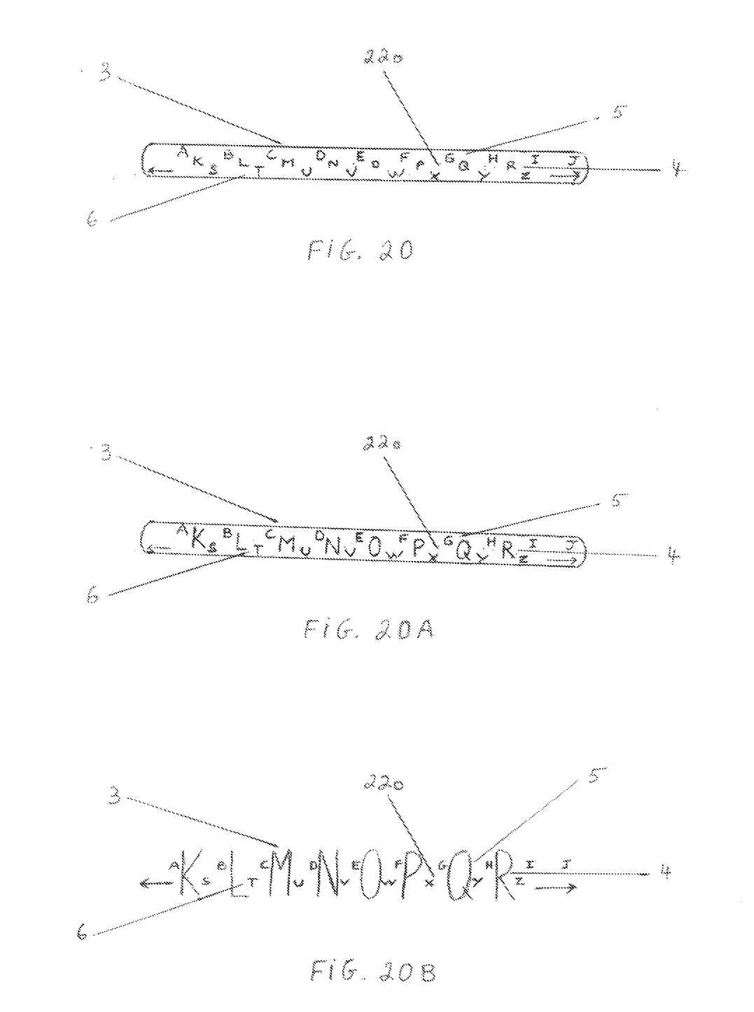

FIG. 20 shows another embodiment (and/or alphabetical characters/keys configuration/arrangement) of the very thin linear virtual keyboard locator unit (such as (3)). Said virtual keyboard locator unit (such as (3)) works, at least substantially and/or preferably, in the same manner (and/or with the same basic principles) than the virtual keyboard locator unit (such as (3)) described in the embodiments of FIG. 1 and FIG. 2. FIG. 20 shows a virtual alphanumerical keyboard locator unit (such as (3)) appearing as an image on the display of a mobile telecommunication device. Said keyboard locator unit (such as (3)) has an overall thin and/or linear shape, and/or the shape of a thin band. Said virtual keyboard locator unit (such as (3)) at least comprises three rows (and/or levels) of alphabetical characters (and/or keys).

Said rows/levels of alphabetical characters/keys have an alphabetical order arrangement starting preferably from the upper external row (such as (5)), continuing on/through the middle row (such as (4)) and finishing on the lower external row (such as (6)). Said three visible rows/levels of alphabetical characters and/or keys are, at least substantially and/or preferably, comprised into said virtual keyboard locator unit (such as (3)) having, preferably but not necessarily, the shape of a thin linear software window. Indeed, and according to the invention, said thin linear virtual keyboard locator does not have to be necessarily surrounded by the visible border lines of a software window.

As shown in the embodiment of FIG. 20, and according to the invention, at least part of the images of the alphabetical characters and/or keys of said upper, middle and lower rows/levels, are at least substantially extending next to (and/or side by side, and/or parallel, and/or contiguous to) each other, as it is also the instance in FIG. 1.

The virtual keyboard locator unit (such as (3)) of FIG. 20A shows a variation from the keyboard locator unit (such as (3)) of FIG. 20. In FIG. 20A, the dimensions (and/or size) of at least a substantial number of the alphabetical characters of the middle row (such as (4)) are increased to the point that the images of said middle row characters insert themselves to the level, and/or in, and/or between, the images of the characters of the upper row (such as (5)) and/or lower row (such as (6)).

As shown in FIG. 20 and FIG. 20A, the original distance (such as (220)) between the upper row (such as (5)) and the lower row (such as (6)) preferably (but not necessarily) remains the same and/or stable. In fact, said upper row (such as (5)) and/or lower row (such as (6)) are not compressed toward one another and/or toward said middle row (such as (4)).

In fact, it is the middle row characters (such as (4)) of the keyboard locator unit (such as (3)) which are enlarged, and/or which expand as a consequence to the levels of the upper row (such as (5)) and lower row (such as (6)). According to the invention, the advantages of the enlargement, and/or expansion, of the dimensions of the images of the alphabetical characters of the middle row/level are:

1) To allow the user to visually distinguish in a clear, and/or quick, and/or intuitive manner, said middle row/level of alphabetical characters from the characters of the two other external upper and/or lower rows/levels. This difference in the dimensions of the characters of the middle row/level creates a visual, and/or intuitive, separation effect between the characters of said middle row/level and the characters of the two other external upper and/or lower rows/levels, and this even if these three rows/levels of characters extend together on a thin linear and/or narrow surface located preferably along one side of the display (such as (2)) of the mobile telecommunication device (such as (1)).

It should be noted that the color of the characters of the middle row/level can also be different from the color of the characters of the other two external rows/levels in order to increase said intuitive visual separation effect; and

2) To create a compact, and/or very thin, virtual keyboard locator unit resulting in part from said at least three rows/levels of alphabetical characters being inserted into one another.

Going further, and as shown in the embodiment of FIG. 20B, the dimensions of the images of the alphabetical characters of the middle row/level (such as (4)) can be increased to the point that said images extend (and/or expand) even higher (and/or further) than the level of the characters of the upper row/level (such as (5)), and/or even lower (and/or further) than the characters of the lower row/level (such as (6)).

In fact, FIG. 20B shows a very thin virtual keyboard locator unit (such as (3)) which can be miniaturized, and comprise alphabetical characters of its upper row and lower rows/levels which are included inside the level of the characters of the middle row. The characters of the middle row/level are intuitively distinguishable from the characters of the upper and lower rows/levels at least because of their different dimensions and/or color. In the embodiment of FIG. 20B, the characters of the upper and lower rows/levels are included into the level of the middle row, and this even if the initial distance between said upper and lower rows (such as (220)) is, at least proportionally, the same (and/or is not decreased).

As shown in the embodiment of FIG. 20B, the characters of the upper and/or lower rows/levels have small dimension (and/or have their dimensions, such as height and/or width, decreased) compare to the dimension of the characters of the middle row/levels. As a consequence, and according to the invention, said small upper and lower rows/levels characters act, and/or are, discrete indicators (and/or locators) of the at least partly invisible keys of said upper and lower rows/levels of characters.

Therefore, according to an embodiment of the invention, a digital processing device comprises a display, said display includes an alphabetical keyboard locator; said locator has an elongated shape extending along at least one side of said display; said locator comprises:

at least partly invisible parts including at least partly invisible keys and/or a row of keys;

visible parts including a set of visible alphabetical characters arranged into one single row; and wherein, within said one single row:

a) some of said alphabetical characters are minimized upward, and indicate locations of the corresponding said at least partly invisible alphabetical keys and/or row of keys, situated on the display at least partly outside and above the visible parts of said locator;
b) some of said alphabetical characters are minimized downward, and indicate locations of the corresponding said at least partly invisible alphabetical keys and/or row of keys, situated on the display at least partly outside and below the visible parts of said locator; and
c) some of said alphabetical characters are not minimized, and indicate locations of the corresponding alphabetical keys located on the display at least on the visible parts of said locator.

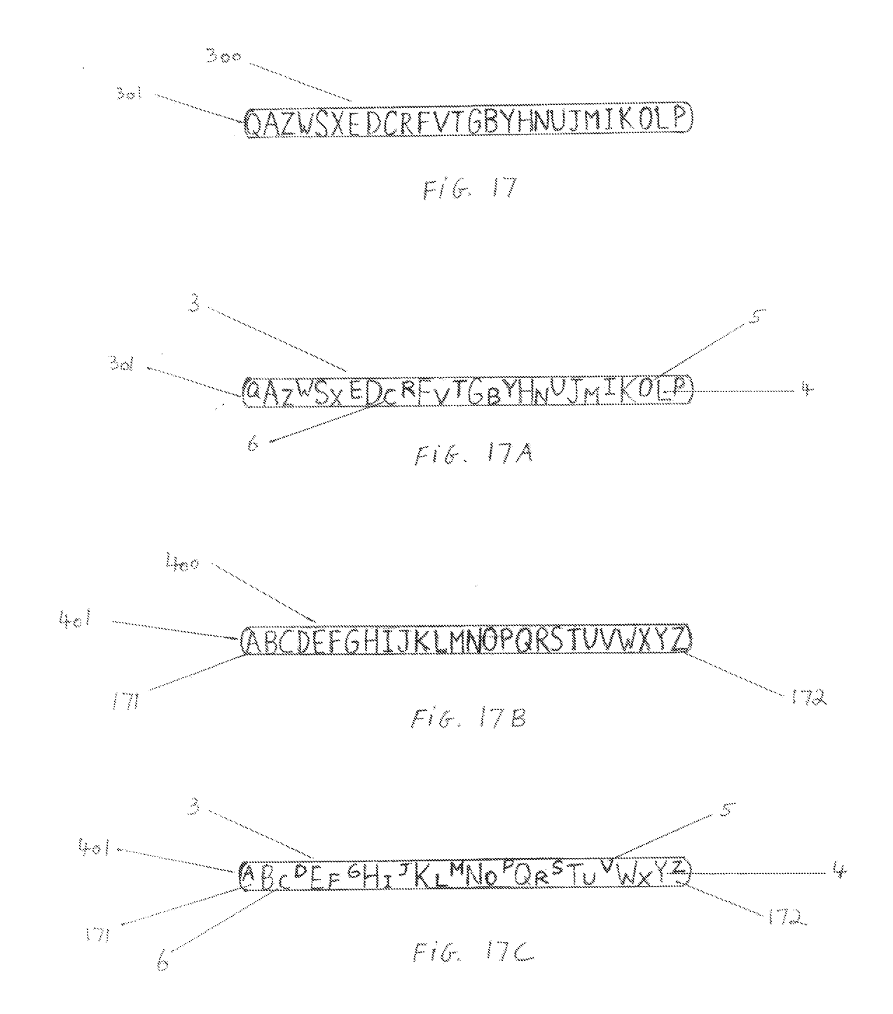

Indeed, and as shown in the embodiment of FIG. 17A, the virtual keyboard locator unit (such as (3)) shows a very thin and strictly one row (and/or one level) of alphabetical characters arranged in a conventional Qwerty order. Said virtual keyboard locator (such as (3)) is the result of a strictly one row/level (such as (300) of FIG. 17) of virtual alphabetical characters organized in a Qwerty alphabetical order, and from which the alphabetical characters of the conventional upper row/level (such as (5)) were minimized (in their dimensions, such as height and/or width) upward, and the alphabetical characters of the conventional lower row/level (such as (6)) were minimized (in their dimensions, such as height and/or width) downward.

The characters/keys of the middle row (such as (4)), of said virtual keyboard locator unit (such as (3)) of FIG. 17A, preferably keep the same original dimensions as in (300) of FIG. 17, while the minimized characters of upper and lower rows/levels are comprised, at least substantially, within the original limits (and/or height/width (301)) of said original strictly one row/level (300) of FIG. 17.

Therefore, according to an embodiment of the invention, said alphabetical characters are arranged in a conventional order of three-row Qwerty keyboard alphabetical characters, and wherein:

A) a conventional upper row of Qwerty keyboard alphabetical characters is represented by the alphabetical characters minimized upward;
B) a conventional lower row of Qwerty keyboard alphabetical characters is represented by the alphabetical characters minimized downward; and
C) a conventional middle row of Qwerty keyboard alphabetical characters is represented by the alphabetical characters that are not minimized.

The characters of the upper row/level (such as (5)) and lower row/level (such as (6)) have their dimensions minimized respectively upward and downward in order:

1) for the user to intuitively distinguish them from the active and/or fully visible characters/keys of the middle row (such (4)), and

2) to transform said minimized characters into small intuitive key indicators that locate at least some of the at least partly invisible keys of said at least partly invisible upper row/level (such as (5)) and lower row/level (such as (6)) of said virtual keyboard locator unit (such as (3)) of FIG. 17A.

Indeed, and according to the invention, said thin linear virtual keyboard locator (such as (3)) of FIG. 17A works with the same basic principles described at length for the thin linear keyboard locators of FIG. 1 or 2.

According to the invention, and as shown in the embodiment of FIG. 17C, the virtual keyboard locator unit (such as (3)) shows a very thin and strictly one row (and/or one level) of alphabetical characters arranged in a conventional alphabetical order from character “A” to character “Z”. In the embodiment of FIG. 17C, said conventional alphabetical order from character “A” to character “Z” starts, for example, from one side/end (such as for the left side/end (171)) to the other side/end (such as the right side/end (172)) of said thin linear keyboard locator unit (such as (3)). The thin linear virtual keyboard locator unit (such as (3) of FIG. 17C) is the result of said strictly one row/level (such as (400) of FIG. 17B) of virtual alphabetical characters organized in a conventional/regular alphabetical order, from the character “A” to the character “Z”, and from which:

1) Some the alphabetical characters were minimized (in their dimensions, such as height and/or width) upward, and

2) Some alphabetical characters of were minimized (in their dimensions, such as height and/or width) downward, and

3) Some alphabetical characters preferably kept their same original dimensions as shown in (400) of FIG. 17B.

According to the invention, and as shown in the embodiment of FIG. 17C, the minimized characters are comprised, at least substantially, within the same original limits (and/or height/width (401)) of said original strictly one row/level (400) of FIG. 17B. The characters of the upper row/level (such as (5)) and lower row/level (such as (6)) have their dimensions minimized respectively upward and downward in order:

1) For the user to intuitively distinguish them from the active and/or fully visible characters/keys of the middle row (such (4)), and

2) To transform said minimized characters into small intuitive key indicators that locate at least some of the at least partly invisible keys of said at least partly invisible upper row/level (such as (5)) and lower row/level (such as (6)) of said virtual keyboard locator unit (such as (3)) of FIG. 17C. Indeed, and according to the invention, said thin linear virtual keyboard locator (such as (3)) of FIG. 17C works with the same basic principles described at length for the thin linear keyboard locators of FIG. 1 or 2.

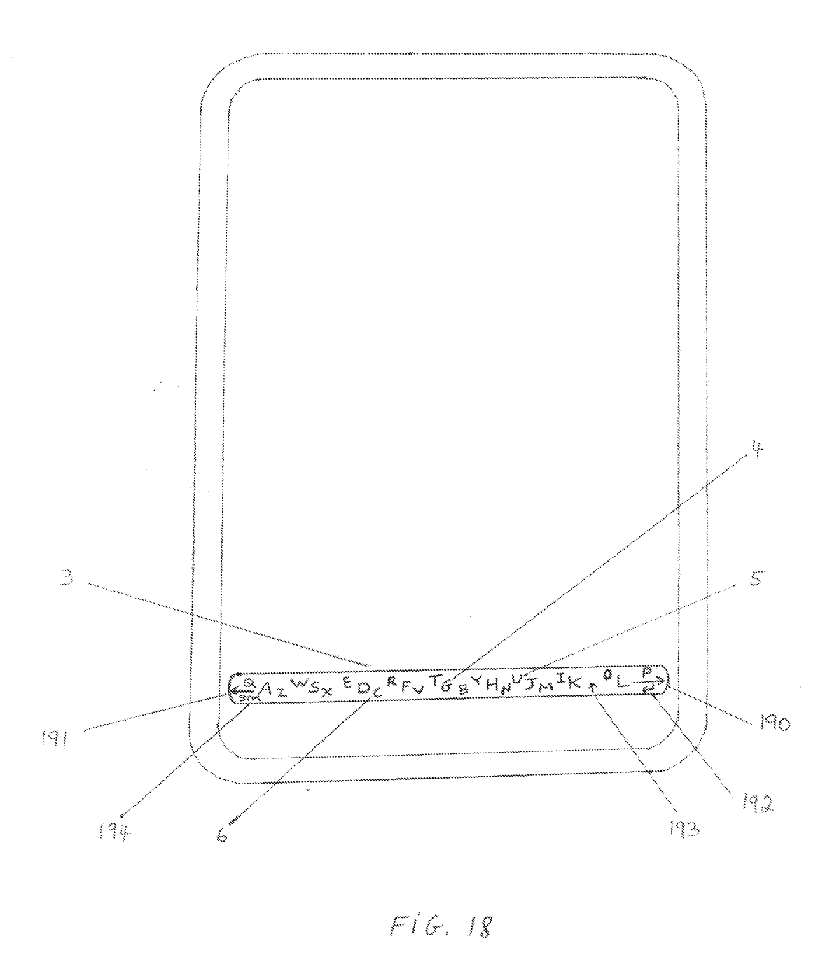

According to the invention, and as shown in FIG. 18, the virtual keyboard locator unit (such as (3)) having a thin linear shape comprises basic commands that are located at least in its middle and/or lower rows/levels. These basic commands include at least several of the following: the “Space” key (190), the “Backspace” key (191), the “Return”/“Enter” key (192), the “Shift” key (193), the “Numerical and/or Symbol” key (194). Preferably, the basic virtual command keys/characters located in the middle row/level (such as (4)) are fully visible (such as the “Space” key (190)). Preferably, the basic virtual command keys/characters located on the lower (and/or upper) row/levels (such as respectively (6) and (5)) are preferably at least partly invisible on the display (such as the “Return”/“Enter” key (192)).

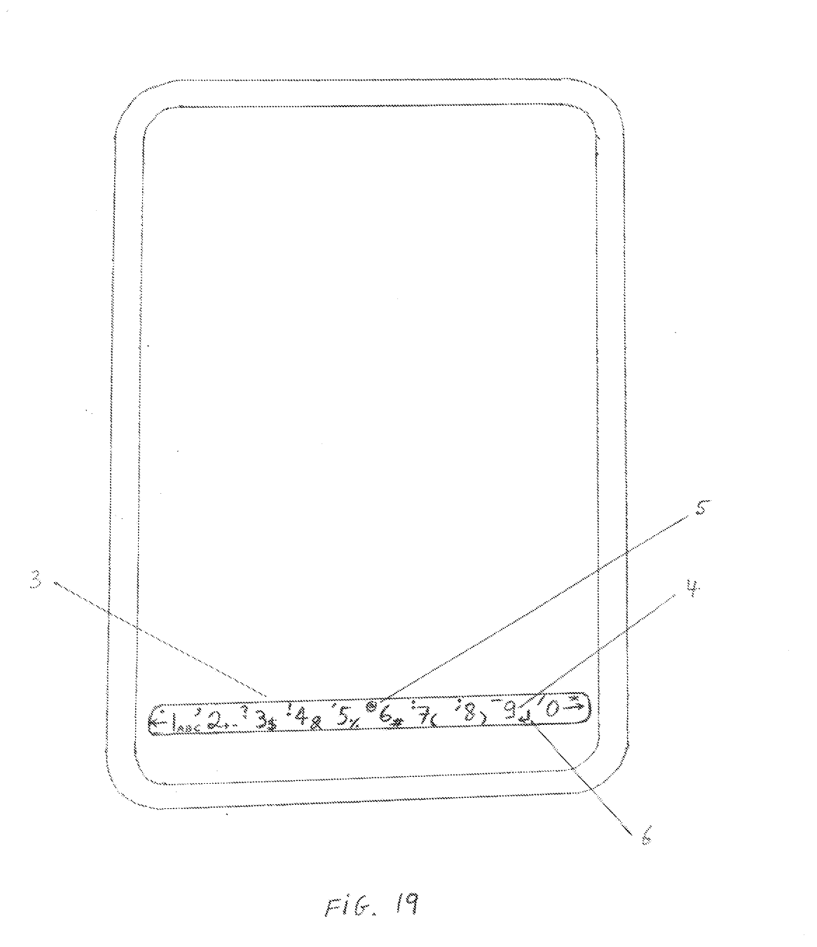

FIG. 19 shows another embodiment of the thin linear virtual keyboard locator unit (such as (3)) in a numerical, and/or symbol, and/or special character mode. Said virtual keyboard locator unit comprises (preferably, but not necessarily) three rows/levels of characters and/or keys. The characters/keys of the middle row/level (such as (4)) are preferably fully visible (and/or active) keys. The keys of the upper and/or lower rows (such as respectively rows/levels (5) and/or (6)) are at least partly invisible.

According to the invention, this numerical, and/or symbol, keyboard locator unit works with the same basic principles described in FIG. 1 and/or FIG. 2. In the embodiment of FIG. 19, the numerical keys and/or characters, are at least placed on said middle, and/or center, row/level, and the keys/characters relating to other symbols (and/or special characters) are at least placed on the upper row/level and/or lower row/level.

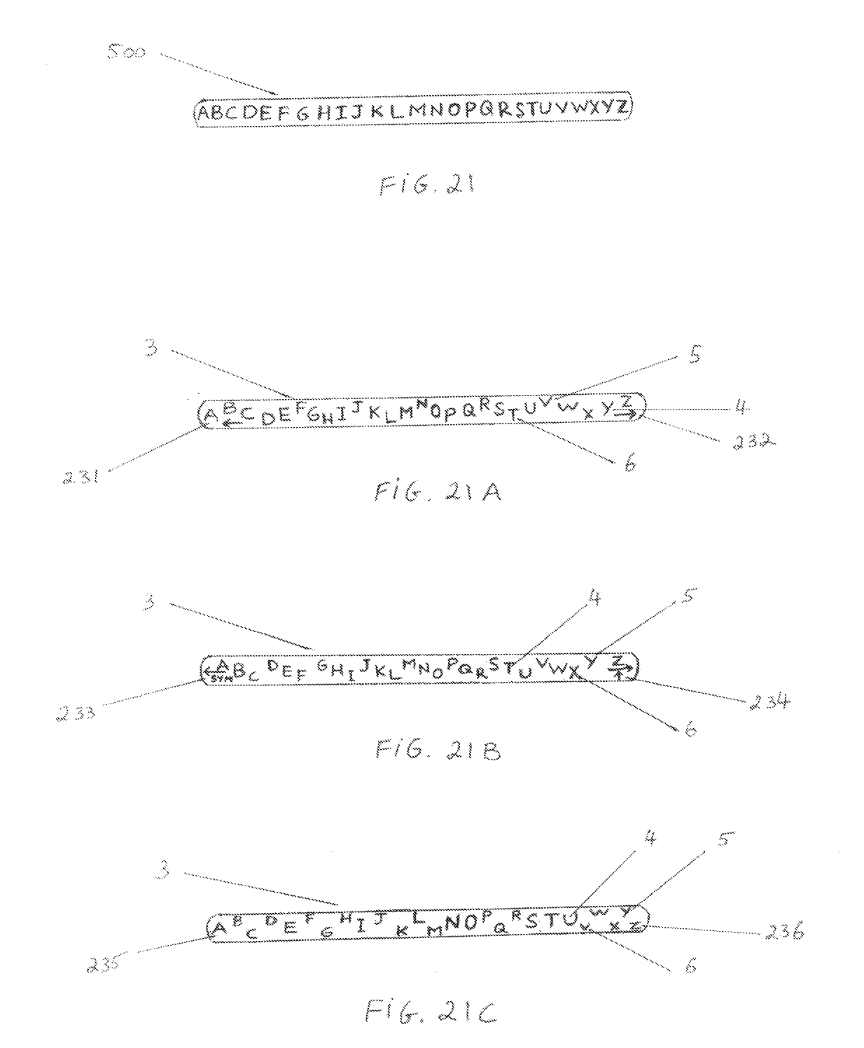

According to the invention, and as shown in the embodiment of FIG. 21A, the virtual keyboard locator unit (such as (3)) has a very thin and/or linear shape of alphabetical characters arranged in a regular/basic alphabetical order from character “A” to character “Z”. This basic alphabetical order from character “A” to character “Z” starts, for example, from one side/end (such as for the left side/end (231)) to the other side/end (such as the right side/end (232)) of said thin linear keyboard locator unit (such as (3)). This thin linear virtual keyboard locator (such as (3)) of FIG. 21A is the result of a strictly one row/level of virtual alphabetical characters (500) of FIG. 21, which are also organized in a regular/basic alphabetical order from the character “A” to the character “Z”, and from which said alphabetical characters are arranged in a “wavy” manner/design, and where for every two characters one character stays on the middle row (such as (4)) while the other character is placed either upward or downward. The characters placed upward form the key indicators/locators of the at least partly invisible upper row/level keys (such as (5)).

The characters placed downward form the key indicators/locators of the at least partly invisible lower row/level keys (such as (6)). Said arrangement allows approximately half of said characters/keys to be located on the middle row (such as (4)) and thus for these keys/characters to be fully visible to the user. Consequently, said “wavy” arrangement of said characters/keys also results in only a small number of said characters/keys to be at least partly invisible on the display. Indeed, and according to the invention, said thin linear virtual keyboard locator (such as (3)) of FIG. 21A works with the same basic principles described at length for the thin linear keyboard locators of FIG. 1 or 2.

According to the invention, and as shown in the embodiment of FIG. 21B, the virtual keyboard locator unit (such as (3)) has a very thin and/or linear shape of alphabetical characters arranged in a regular/basic alphabetical order from character “A” to character “Z”. This basic alphabetical order from character “A” to character “Z” starts, for example, from one side/end (such as for the left side/end (233)) to the other side/end (such as the right side/end (234)) of said thin linear keyboard locator unit (such as (3)). This thin linear virtual keyboard locator (such as (3)) of FIG. 21B is the result of a strictly one row/level of virtual alphabetical characters (500) of FIG. 21, which are also organized in a regular/basic alphabetical order from the character “A” to the character “Z”, and from which said alphabetical characters are arranged in a visually synchronized manner having a “\” or “slash” shape.

In said arrangement of FIG. 21B, every three alphabetical characters are arranged in this easily recognizable “slash” manner and/or design. For every three characters, one is placed upward, one stays in the middle/center row (such as (4)), and one will be placed downward. The characters placed upward at least form the key indicators and/or locators of the at least partly invisible upper row of keys (such as (5)). The characters placed downward at least form the key indicators and/or locators of the at least partly invisible lower row of keys (such as (6)). The characters which stay on the middle row/level (such as (4)) are preferably fully visible and/or active keys. Indeed, and according to the invention, said thin linear virtual keyboard locator (such as (3)) of FIG. 21B works with the same basic principles described at length for the thin linear keyboard locators of FIG. 1 or 2.

According to the invention, and as shown in the embodiment of FIG. 21C, the virtual keyboard locator unit (such as (3)) has a very thin and/or linear shape of alphabetical characters arranged in a regular/basic alphabetical order from character “A” to character “Z”. This basic alphabetical order from character “A” to character “Z” starts, for example, from one side/end (such as for the left side/end (235)) to the other side/end (such as the right side/end (236)) of said thin linear keyboard locator unit (such as (3)). This thin linear virtual keyboard locator (such as (3)) of FIG. 21C is the result of a strictly one row/level of virtual alphabetical characters (500) of FIG. 21, which are also organized in a regular/basic alphabetical order from the character “A” to the character “Z”, and from which said alphabetical characters are arranged based on the following principle:

1) The alphabetical characters that are on average the most used in a text entry are placed on the middle row (such as (4)) in order for their keys to be fully visible to the user, and

2) The characters that are on average the less used in a text entry are placed upward and/or downward. The characters placed upward form the key indicators and/or locators of the at least partly invisible upper row (such as (5)). The characters placed downward form the key indicators and/or locators of the at least partly invisible lower row (such as (6)). Preferably, this arrangement of the 26 characters of the alphabet will place said characters evenly between the three rows, in order not to place too many characters on any of said three rows. Indeed, and according to the invention, said thin linear virtual keyboard locator (such as (3)) of FIG. 21C works with the same basic principles described at length for the thin linear keyboard locators of FIG. 1 or 2.

It is very important to notice that all of the figures of this patent application relating to the invention of the thin linear virtual keyboard locator only show different embodiments in the configuration, and/or design, and/or arrangement of the characters of said very thin linear virtual keyboard locator. Indeed, it is very important to remember that all said different embodiments and/or examples in the configuration, and/or design, and/or arrangement of the characters of said very thin linear virtual keyboard locator work with, and/or obey to, the same basic principles and ideas described at length in FIG. 1 and FIG. 2 of this patent application.

According to the invention, the keys of the at least three rows/levels of the very thin virtual keyboard locator unit can be:

1) Unambiguous keys comprising only one alphabetical character per key and which are capable to produce only one alphabetical character when they are selected by the user, and/or

2) Ambiguous keys comprising at least two alphabetical characters per keys and which are capable to produce at least various alphabetical characters when they are selected by the user.

As a consequence, and according to the invention, the visible characters and/or keys of the upper and/or lower rows/levels of said unit can indicate the locations on the display of at least partly invisible unambiguous and/or ambiguous keys of said upper and/or lower rows/levels. Also, the visible characters and/or keys of the middle row/level of said unit can show the actual location of the fully active and/or visible unambiguous and/or ambiguous keys of said middle row/level.

As stated previously, and according to the invention, the unambiguous, and/or precise, data input/entry system of the very thin linear virtual keyboard locator of this invention (including any of the very thin linear virtual keyboard locator units of this invention working with the same basic principles/ideas that the very thin linear virtual keyboard locator units of FIG. 1 and/or FIG. 2) can also be supported by any type of ambiguous, and/or predictive, data input/entry system.

Indeed, and according to the invention, any of said very thin linear virtual keyboard locator units can function with any type of unambiguous data input/entry system and/or with any type of ambiguous/predictive data input/entry system, on any of their visible and/or invisible zones. For example, a data input/entry system of the very thin linear virtual keyboard locator unit of this invention can input/enter unambiguously only one character assigned to a zone of the display selected by the user, and/or can also input/enter, and/or consider to input/enter, multiple characters, and/or also other characters, assigned and/or not assigned to said zone of the display selected by the user, in particular if said ambiguous input/entry is at least deemed relevant to said word prediction system and/or its dictionary of words.

According to the invention, and as shown in the embodiment of FIG. 1, at least one key of the visible keys, and/or at least one key of the at least partly invisible keys, of the very thin (and/or elongated, and/or linear) virtual keyboard locator unit (such as (3)), can be selected through any type of input technology (and/or means) such as a swipe of the user's finger on (and/or toward) a zone/area on the display assigned to any of said keys.

For example, and according to the invention, a swipe of the user's finger on a visible zone of said virtual keyboard locator unit (such as (3)) will preferably select at least one key of the fully visible middle row (such as (4)) and which key is located on at least part of the zone touched by said swipe movement.

Moreover, for example and according to the invention, a swipe of the user's finger on (and/or toward) a zone of the display located outside said visible area of said virtual keyboard locator unit (such as (3)) preferably selects at least one key of the at least partly invisible upper row (such as (5)), and/or lower row (such as (6)), depending if said swipe movement is located (and/or directed) on (and/or toward) at least part of the zone assigned to said at least one key of said upper and/or lower rows.

I claim:

1. A digital processing device comprising a display, said display includes an alphabetical keyboard locator; said locator has an elongated shape extending along at least one side of said display; said locator comprises:
at least partly invisible parts including at least partly invisible keys and/or a row of keys;
visible parts including a set of visible alphabetical characters arranged into three rows: an upper row, a middle row, and a lower row, and wherein:
a) the alphabetical characters of the middle row indicate locations of the corresponding visible alphabetical keys and/or row of keys, situated at least on said visible parts;
b) the alphabetical characters of the upper row indicate locations of said at least partly invisible keys and/or row of keys, located on the display at least partly outside and above said visible parts; and
c) the alphabetical characters of the lower row indicate locations of at least partly invisible keys, and/or row of keys, situated on the display at least partly outside and below said visible parts.

2. The device according to claim 1, wherein said three rows are arranged in a conventional order of three-row Qwerty keyboard alphabetical characters, and wherein:
a) a conventional middle row of Qwerty keyboard alphabetical characters is represented by the alphabetical characters of the middle row of said locator;
b) a conventional upper row of Qwerty keyboard alphabetical characters is represented by the alphabetical characters of the upper row of said locator; and
c) a conventional lower row of Qwerty keyboard alphabetical characters is represented by the alphabetical characters of the lower row of said locator.

3. The device according to claim 1, wherein at least some of the visible alphabetical characters of said middle row are operatively increased to a predetermined dimension such that the characters of said middle row can be operatively inserted between the characters of said upper row and/or said lower row, in order to provide:
a) a compact shape of said locator, and
b) an intuitive visual separation effect between said three rows of visible alphabetical characters arranged together into an elongated shape.

4. The device according to claim 1, wherein the visible alphabetical characters of said middle row have a color different from a color of the visible alphabetical characters of said upper row and/or said lower row in order to provide an intuitive visual separation effect between said three rows.

5. A digital processing device comprising a display, said display includes an alphabetical keyboard locator; said locator has an elongated shape extending along at least one side of said display; said locator comprises:
at least partly invisible parts including at least partly invisible keys and/or a row of keys;
visible parts including a set of visible alphabetical characters arranged into one single row; and wherein, within said one single row:
a) some of said alphabetical characters are minimized upward, and indicate locations of the corresponding said at least partly invisible alphabetical keys and/or row of keys, situated on the display at least partly outside and above the visible parts of said locator;
b) some of said alphabetical characters are minimized downward, and indicate locations of the corresponding said at least partly invisible alphabetical keys and/or row of keys, situated on the display at least partly outside and below the visible parts of said locator; and
c) some of said alphabetical characters are not minimized, and indicate locations of the corresponding alphabetical keys located on the display at least on the visible parts of said locator.

6. The device according to claim 5, said alphabetical characters are arranged in a conventional order of three-row Qwerty keyboard alphabetical characters, and wherein:
A) a conventional upper row of Qwerty keyboard alphabetical characters is represented by the alphabetical characters minimized upward;
B) a conventional lower row of Qwerty keyboard alphabetical characters is represented by the alphabetical characters minimized downward; and
C) a conventional middle row of Qwerty keyboard alphabetical characters is represented by the alphabetical characters that are not minimized.
